(19) United States
(12) Patent Application Publication
(10) Pub. No.: US 2022/0013788 A1
(43) Pub. Date: Jan. 13, 2022

(54) Rolled 3D Aluminum Secondary Batteries

(71) Applicant: Global Graphene Group, Inc., Dayton, OH (US)

(72) Inventors: Aruna Zhamu, Springboro, OH (US); Bor Z. Jang, Centerville, OH (US)

(21) Appl. No.: 16/927,404

(22) Filed: Jul. 13, 2020

(51) Int. Cl. H01M 4/66; H01M 4/62; H01M 4/36; H01M 10/054

(52) U.S. Cl. CPC H01M 4/662; H01M 4/663; H01M 4/622; H01M 2004/021; H01M 4/364; H01M 10/054; H01M 4/366

(57) ABSTRACT

Provided is rolled aluminum secondary battery comprising an anode, a cathode, a porous or ion-permeable separator, and an electrolyte, wherein the anode contains aluminum metal or an aluminum metal alloy optionally supported by a current collector and the cathode contains a wound cathode roll of a cathode active material having a cathode roll length, a cathode roll width, and a cathode roll thickness, wherein the cathode active material contains isolated graphene sheets, expanded graphite flakes, and/or graphite flakes of exfoliated graphite worms that are aligned substantially parallel to a plane defined by the cathode roll length and the cathode roll width; and wherein the cathode roll width is substantially perpendicular to the separator in such a manner that the aligned graphene sheets or graphite flakes have a graphene edge plane in direct contact with the electrolyte and facing the separator.

The present disclosure relates generally to the field of rechargeable aluminum battery and, particularly, to 3D rolled aluminum metal or aluminum-ion cells having a relatively high energy density and power density and a method of manufacturing this aluminum battery.

### BACKGROUND

Historically, today's most favorite rechargeable energy storage devices—lithium-ion batteries—was actually evolved from rechargeable “lithium metal batteries” that use lithium (Li) metal as the anode and a Li intercalation compound (e.g. MoS₂) as the cathode. Li metal is an ideal anode material due to its light weight (the lightest metal), high electronegativity (−3.04 V vs. the standard hydrogen electrode), and high theoretical capacity (3,860 mAh/g). Based on these outstanding properties, lithium metal batteries were proposed 40 years ago as an ideal system for high energy-density applications.

Due to some safety concerns of pure lithium metal, graphite was later implemented as an anode active material in place of the lithium metal to produce the current lithium-ion batteries. The past two decades have witnessed a continuous improvement in Li-ion batteries in terms of energy density, rate capability, and safety. However, the use of graphite-based anodes in Li-ion batteries has several significant drawbacks: low specific capacity (theoretical capacity of 372 mAh/g as opposed to 3,860 mAh/g for Li metal), long Li intercalation time (e.g. low solid-state diffusion coefficients of Li in and out of graphite and inorganic oxide particles) requiring long recharge times (e.g. 7 hours for electric vehicle batteries), inability to deliver high pulse power, and necessity to use pre-lithiated cathodes (e.g. lithium cobalt oxide, as opposed to cobalt oxide), thereby limiting the choice of available cathode materials. Further, these commonly used cathode active materials have a relatively low lithium diffusion coefficient (typically D˜10⁻¹⁶-10⁻¹¹ cm²/sec). These factors have contributed to one major shortcoming of today's Li-ion batteries—a moderate energy density (typically 150-220 Wh/kg_{cell}), but extremely low power density (typically <0.5 kW/kg).

Supercapacitors are being considered for electric vehicle (EV), renewable energy storage, and modern grid applications. The supercapacitors typically operate on using porous electrodes having large surface areas for the formation of diffuse double layer charges. This electric double layer capacitance (EDLC) is created naturally at the solid-electrolyte interface when voltage is imposed. This implies that the specific capacitance of an EDLC-type supercapacitor is directly proportional to the specific surface area of the electrode material, e.g. activated carbon. This surface area must be accessible by the electrolyte and the resulting interfacial zones must be sufficiently large to accommodate the EDLC charges.

This EDLC mechanism is based on ion adsorption on surfaces of an electrode. The required ions are pre-existing in a liquid electrolyte and do not come from the opposite electrode. In other words, the required ions to be deposited on the surface of a negative electrode (anode) active material (e.g., activated carbon particles) do not come from the positive electrode (cathode) side, and the required ions to be deposited on the surface of a cathode active material do not come from the anode side. When a supercapacitor is re-charged, local positive ions are deposited close to a surface of a negative electrode with their matting negative ions staying close side by side (typically via local molecular or ionic polarization of charges). At the other electrode, negative ions are deposited close to a surface of this positive electrode with the matting positive ions staying close side by side. Again, there is no exchange of ions between an anode active material and a cathode active material.

In some supercapacitors, the stored energy is further augmented by pseudo-capacitance effects due to some local electrochemical reactions (e.g., redox). In such a pseudo-capacitor, the ions involved in a redox pair also pre-exist in the same electrode. Again, there is no exchange of ions between the anode and the cathode.

Since the formation of EDLC does not involve a chemical reaction or an exchange of ions between the two opposite electrodes, the charge or discharge process of an EDLC supercapacitor can be very fast, typically in seconds, resulting in a very high power density (typically 2-8 kW/kg). Compared with batteries, supercapacitors offer a higher power density, require no maintenance, offer a much higher cycle-life, require a very simple charging circuit, and are generally much safer. Physical, rather than chemical, energy storage is the key reason for their safe operation and extraordinarily high cycle-life.

Despite the positive attributes of supercapacitors, there are several technological barriers to widespread implementation of supercapacitors for various industrial applications. For instance, supercapacitors possess very low energy densities when compared to batteries (e.g., 5-8 Wh/kg for commercial supercapacitors vs. 20-40 Wh/kg for the lead acid battery and 50-100 Wh/kg for the NiMH battery). Modern lithium-ion batteries possess a much higher energy density, typically in the range from 150-220 Wh/kg, based on the cell weight.

Secondary batteries based on various charge-discharge principles other than lithium ions have been proposed. Among them, some attention has been paid to aluminum secondary batteries based on the deposition-dissolution reaction of aluminum (Al) at the anode. Aluminum has a high ionization tendency and is capable of three-electron redox reactions, which can potentially enable an aluminum battery to deliver a high capacity and high energy density.

The abundance, low cost, and low flammability of Al, and its ability to undergo three-electron redox imply that rechargeable Al-based batteries could in principle offer cost-effectiveness, high capacity and safety. However, the rechargeable Al batteries developed over the past 30 years have failed to make it to the marketplace. This has been likely due to problems such as cathode material disintegration, low cell discharge voltage (e.g. 0.55V), a capacitive behavior without a discharge voltage plateau (e.g. 1.1-0.2 V), and short cycle life (typically <100 cycles) with rapid capacity decay (by 26-85% over 100 cycles), low cathode specific capacity, and low cell-level energy density (<50 Wh/kg).

For instance, Jayaprakash reports an aluminum secondary battery that shows a discharge curve having a plateau at 0.55 V [Jayaprakash, N., Das, S. K. & Archer, L. A. “The rechargeable aluminum-ion battery,” Chem. Commun. 47, 12610-12612 (2011)]. A rechargeable battery having an output voltage lower than 1.0 volt has a limited scope of application. As a point of reference, alkaline battery has an output voltage of 1.5 volts and a lithium-ion battery has a typical cell voltage of 3.2-3.8 volts. Furthermore, even with an initial cathode specific capacity as high as 305 mAh/g, the energy storage capability of the cathode is approximately 0.55 V×305 mAh/g=167.75 Wh/kg based on the cathode active material weight alone (not based on the total cell weight). Thus, the cell-level specific energy (or gravimetric energy density) of this Al—V₂O₅ cell is approximately 167.75/3.6=46.6 Wh/kg (based on the total cell weight).

(As a point of reference, a lithium-ion battery having a lithium iron phosphate (LFP) as the cathode active material (having a theoretical specific capacity of 170 mAh/g) delivers an output voltage of 3.2 volts and an energy storage capability of 3.2 V×170 mAh/g=544 Wh/kg (based on the LFP weight only). This cell is known to deliver a cell-level energy density of approximately 150 Wh/kg. There is a reduction factor of 544/150=3.6 to convert a cathode active material weight-based energy density value to a total cell weight-based energy density value in this battery system.)

As another example, Rani reports an aluminum secondary battery using a lightly fluorinated natural graphite as the cathode active material having an output voltage varying from 0.2 volts to 1.1 volts [Rani, J. V., Kanakaiah, V., Dadmal, T., Rao, M. S. & Bhavanarushi, S. “Fluorinated natural graphite cathode for rechargeable ionic liquid based aluminum-ion battery,” J. Electrochem. Soc. 160, A1781-A1784 (2013)]. With an average voltage of approximately 0.65 volts and a discharge capacity of 225 mAh/g, the cell delivers an energy storage capability of 0.65×225=146.25 Wh/kg (of the cathode active material weight only) or cell-level specific energy of 146.25/3.6=40.6 Wh/kg (based on the total cell weight).

As yet another example, Lin, et al. reports an aluminum-graphite foam cell that exhibits a plateau voltage near 2 volts and an output voltage of 70 mAh/g [Lin M C, Gong M, Lu B, Wu Y, Wang D Y, Guan M, Angell M, Chen C, Yang J, Hwang B J, Dai H., “An ultrafast rechargeable aluminum-ion battery,” Nature. 2015 Apr. 16; 520 (7547):325-8]. The cell-level specific energy is expected to be approximately 70×2.0/3.6=38.9 Wh/kg. As a matter of fact, Lin, et al. has confirmed that the specific energy of their cell is approximately 40 Wh/kg.

Clearly, an urgent need exists for an aluminum secondary battery that provide proper discharge voltage profiles (having a high average voltage and/or a high plateau voltage during discharge), high specific capacity at both high and low charge/discharge rates (not just at a low rate), and long cycle-life. Hopefully, the resulting aluminum battery can deliver some positive attributes of a supercapacitor (e.g. long cycle life and high power density) and some positive features of a lithium-ion battery (e.g. moderate energy density). These are the main objectives of the instant disclosure.

### SUMMARY

The present disclosure provides a cathode or positive electrode layer in a roll shape for an aluminum secondary battery (rechargeable aluminum battery or aluminum-ion battery) and an aluminum secondary battery containing such a cathode roll having a roll thickness direction substantially perpendicular to a separator layer, or inclined at an angle from 15 to 90 degrees with respect to the separator plane.

In some preferred embodiments, the disclosure provides a rolled aluminum secondary battery comprising an anode, a cathode, a porous or ion-permeable separator electronically separating the anode and the cathode, and an electrolyte in ionic contact with the anode and the cathode to support reversible deposition and dissolution of aluminum at the anode, wherein the anode contains aluminum metal or an aluminum metal alloy as an anode active material and the cathode contains a wound cathode roll of a cathode active material having a cathode roll length, a cathode roll width, and a cathode roll thickness, wherein the cathode active material contains isolated graphene sheets, expanded graphite flakes, recompressed exfoliated graphite worms having constituent graphite flakes, or a combination thereof that are aligned or oriented substantially parallel to a plane defined by the cathode roll length and the cathode roll width; and wherein the cathode roll width is substantially perpendicular to the separator in such a manner that the aligned or oriented graphene sheets or graphite flakes have a graphene edge plane in direct contact with the electrolyte and facing the separator.

In the instant application, graphite flakes collectively refer to the expanded graphite flakes and the flakes that constitute exfoliated graphite worms. Typically, exfoliated graphite worms contain constituent graphite flakes that are 10-1000 nm in thickness and are largely interconnected. The exfoliated graphite worms may be broken into expanded graphite flakes using mechanical shearing (e.g. a household food processor), ultrasonication, or air jet milling, etc.

Such a roll shape structure in such a geometric arrangement readily admits ions from the electrolyte and release ions into electrolyte and the ions permeating through the porous separator can readily enter the inter-graphene spaces near the edge plane, leading to a higher rate capability and higher power.

The isolated graphene sheets are preferably selected from a pristine graphene or a non-pristine graphene material, having a content of non-carbon elements greater than 2% by weight, selected from graphene oxide, reduced graphene oxide, graphene fluoride, graphene chloride, graphene bromide, graphene iodide, hydrogenated graphene, nitrogenated graphene, chemically functionalized graphene, doped graphene, or a combination thereof.

The graphene sheets and/or graphite flakes may be bonded together by a binder. The binder may be chemically cured while the oriented graphene sheets are in a compression state.

In certain embodiments, the cathode roll of compressed and oriented graphene sheets/graphite flakes has a physical density from 0.5 to 2.0 g/cm³ and has meso-scaled pores having a pore size from 2 nm to 50 nm. In some preferred embodiments, the cathode roll of graphene sheets/graphite flakes has a physical density from 1.1 to 1.8 g/cm³ and has pores having a pore size from 2 nm to 5 nm. In certain embodiments, the graphene sheets have a specific surface area from 20 to 2,630 m²/g. Preferably, the specific surface area is from 20 to 1,500 m²/g, more preferably from 20 to 500 m²/g.

Preferably, the oriented graphene sheets and/or graphite flakes in the cathode layer are bonded together by a binder. Preferably, the binder is an electrically conducting polymer, such as polyaniline, polypyrrole, polythiophene, and other intrinsically conducting polymers (e.g. conjugate chain polymers). The conducting polymer binder amount may be from 0.1% to 15% by weight. Non-conducting resins can also be used as a binder, but the amount is preferably from 0.1% to 10% and more preferably less than 8% by weight. Preferably, the binder is chemically cured while the oriented graphene sheets/graphite flakes are in a compression state so that the sizes of the inter-graphene spaces can be maintained during battery charge/discharge cycles.

In certain embodiments, the electrolyte also supports reversible intercalation and de-intercalation of ions (cations, anions, or both) at the cathode. The aluminum alloy preferably contains at least 80% by weight Al element in the alloy (more preferably at least 90% by weight). There is no restriction on the type of alloying elements that can be chosen. Preferably, the alloying elements for Al are Si, B, Mg, Ti, Sc, etc.

This aluminum secondary battery can further comprise an anode current collector supporting the aluminum metal or aluminum metal alloy or further comprise a cathode current collector supporting the cathode active layer (i.e. graphene sheets and/or graphite flakes). The current collector can be a mat, paper, fabric, foil, or foam that is composed of conducting nano-filaments, such as graphene sheets, carbon nanotubes, carbon nano-fibers, carbon fibers, graphite nano-fibers, graphite fibers, carbonized polymer fibers, or a combination thereof, which form a 3D network of electron-conducting pathways. The high surface areas of such an anode current collector not only facilitate fast and uniform dissolution and deposition of aluminum ions, but also act to reduce the exchange current density and, thus, reduce the tendency to form metal dendrites that otherwise could cause internal shorting.

In certain preferred embodiments, the anode current collector having aluminum metal or alloy coated thereon may be rolled up to become an anode roll. The anode roll and the cathode roll may have the same or different dimensions.

The oriented graphene sheets and/or expanded graphite flakes are preferably produced (by thermal exfoliation and mechanical shearing) from meso-phase pitch, meso-phase carbon, meso carbon micro-beads (MCMB), coke particles, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof, which are heavily intercalated, oxidized, fluorinated, etc.

The above-listed carbon/graphite material may be subjected to an inter-planar spacing expansion treatment, followed by a thermal exfoliation and recompression. The expansion treatment is conducted to increase the inter-planar spacing between two graphene planes in a graphite crystal, from a typical value of 0.335-0.36 nm to a typical value of 0.43-1.2 nm for the main purpose of weakening the van der Waals forces that hold neighboring graphene planes together. This would make it easier for subsequent thermal exfoliation. This expansion treatment includes an oxidation, fluorination, bromination, chlorination, nitrogenation, intercalation, combined oxidation-intercalation, combined fluorination-intercalation, combined bromination-intercalation, combined chlorination-intercalation, or combined nitrogenation-intercalation of the graphite or carbon material. The above procedure is followed by a thermal exfoliation without constraint. Unconstrained thermal exfoliation typically results in the formation of exfoliated graphite/carbon worms. The exfoliated graphite/carbon worms are then subjected to low-intensity mechanical shearing (e.g. ultrasonication, air jet milling, ball-milling, wet milling, etc.) to produce expanded graphite flakes. High-intensity shearing of exfoliated graphite worms yields isolated/separated graphene sheets.

Multiple graphene sheets and/or graphite flakes are then compressed and rolled (wound) to produce a roll of layer of aligned (oriented) graphene sheets/graphite flakes that are oriented in such a manner that the layer has a graphene edge plane in direct contact with the electrolyte and facing or contacting the separator. The layer of oriented graphene sheets/graphite flakes typically has a physical density from 0.5 to 2.0 g/cm³ (preferably from 1.0 to 1.8 g/cm³) and has meso-scaled pores having a pore size from 2 nm to 50 nm, preferably from 2 nm to 20 nm.

Due to the expansion treatments, the oriented graphene sheets or graphite flakes can contain a non-carbon element selected from oxygen, fluorine, chlorine, bromine, iodine, nitrogen, hydrogen, or boron. Thus, the graphene sheets can be selected from pristine graphene (essentially all-carbon), graphene oxide, reduced graphene oxide, graphene fluoride, graphene chloride, graphene bromide, graphene iodide, nitrogenated graphene, hydrogenated graphene, boron-doped graphene, or a combination thereof.

In the disclosed aluminum secondary battery, the electrolyte may be selected from an aqueous electrolyte, organic electrolyte, molten salt electrolyte, ionic liquid electrolyte, or a combination thereof. A polymer may be added to the electrolyte. Preferably, the electrolyte contains an aluminum salt such as, AlF₃, AlCl₃, AlBr₃, AlI₃, AlFₓCl₍₃₋ₓ₎, AlBrₓCl₍₃₋ₓ₎, AlIₓCl₍₃₋ₓ₎, or a combination thereof, wherein x is from 0.01 to 2.0. Mixed aluminum halides, such as AlFₓCl₍₃₋ₓ₎, AlBrₓCl₍₃₋ₓ₎, AlIₓCl₍₃₋ₓ₎, can be readily produced by brominating, fluorinating, or iodizing AlCl₃ to a desired extent; for instance at 100-350° C. for 1-24 hours.

Preferably, the electrolyte contains an ionic liquid that contains an aluminum salt mixed with an organic chloride selected from n-butyl-pyridinium-chloride (BuPyCl), 1-methyl-3-ethylimidazolium-chloride (MEICl), 2-dimethyl-3-propylimidazolium-chloride, 1,4-dimethyl-1,2,4-triazolium chloride (DMTC), or a mixture thereof.

In certain embodiments, the layer of oriented graphene sheets/graphite flakes of the cathode roll also functions as a cathode current collector to collect electrons during a discharge of the aluminum secondary battery and wherein the battery contains no separate or additional cathode current collector.

The cathode roll of oriented graphene sheets/graphite flakes may further comprise an electrically conductive binder material which bonds oriented graphene sheets/graphite flakes together to form a cathode electrode. The electrically conductive binder material may be selected from coal tar pitch, petroleum pitch, meso-phase pitch, a conducting polymer, a polymeric carbon, or a derivative thereof.

The rolled aluminum secondary battery may further comprise an anode current collector supporting the aluminum metal or aluminum metal alloy wherein the anode current collector contains (a) a layer of supporting solid substrate having two primary surfaces wherein either one or both of the primary surfaces are coated with the aluminum metal or aluminum metal alloy or (b) a layer of supporting porous substrate having pores that are impregnated with the aluminum metal or aluminum metal alloy

Typically, the disclosed rolled aluminum secondary battery has an average discharge voltage no less than 1 volt (typically and preferably >1.5 volts) and a cathode specific capacity greater than 100 mAh/g (preferably and more typically >150 mAh/g, and most preferably >200 mAh/g), based on a total cathode active layer weight.

Preferably, the aluminum secondary battery has an average discharge voltage no less than 2.0 volts and a cathode specific capacity greater than 70 mAh/g based on a total cathode active layer weight (preferably and more typically >100 mAh/g, and most preferably >150 mAh/g).

The present disclosure also provides a cathode active layer, in a roll form, for an aluminum secondary battery. The cathode active layer comprises oriented graphene sheets/graphite flakes having inter-graphene or inter-flake spaces or pores from 2 nm to 10 μm in size. Preferably, the oriented graphene sheets and/or expanded graphite flakes are a high-level thermal exfoliation product of meso-phase pitch, meso-phase carbon, meso carbon micro-beads (MCMB), coke particles, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof.

The carbon or graphite material has an original inter-planar spacing d₀₀₂ from 0.27 nm to 0.42 nm prior to an expansion treatment and the inter-planar spacing d₀₀₂. is increased to a range from 0.43 nm to 1.2 nm after the expansion treatment between essentially all the constituent graphene planes (hexagonal planes of carbon atoms). Preferably, the expanded carbon or graphite material (e.g. highly intercalated/oxidized) is subsequently thermally exfoliated to the extent that substantially all the constituent graphene planes are fully separated from one another. In other words, in these favorable situations (e.g. all stage-1 graphite intercalation compound or every graphene plane being highly oxidized), separate, isolated graphene sheets are formed during thermal exfoliation. In slightly less favorable conditions, the thermally exfoliated graphite is highly separated graphite worms that still contain interconnected graphite flakes. These loosely connected graphite flakes in the worms can then be readily and easily broken and separated into isolated graphene sheets or platelets. Multiple graphene sheets or platelets can then be recompressed to form a layer or block of highly oriented graphene sheets.

In certain embodiments, the present disclosure provides a rolled aluminum secondary battery comprising an anode current collector, an anode, a cathode, a cathode current collector, an ion-permeable separator that electronically separates the anode and the cathode, and an electrolyte in ionic contact with the anode and the cathode, wherein the anode contains aluminum metal or an aluminum metal alloy as an anode active material and the cathode contains a wound roll of an electrolyte-impregnated laminar graphene/graphite flake structure, wherein this laminar graphene/graphite structure comprises multiple graphene sheets and/or graphite flakes being alternately spaced by thin electrolyte layers, less than 10 nm in thickness (preferably less than 5 nm), and the multiple graphene sheets or graphite flakes are substantially aligned along a desired direction substantially perpendicular to the separator layer, and wherein the laminar graphene/graphite structure has a physical density from 0.5 to 1.7 g/cm³ and a specific surface area from 50 to 3,300 m²/g, when measured in a dried state of the laminar graphene structure with the electrolyte removed.

The electrolyte in the rolled aluminum secondary battery may be selected from an aqueous electrolyte, organic electrolyte, molten salt electrolyte, ionic liquid electrolyte, or a combination thereof. In some preferred embodiments, the electrolyte contains AlF₃, AlCl₃, AlBr₃, AlI₃, AlFₓCl₍₃₋ₓ₎, AlBrₓCl₍₃₋ₓ₎, AlIₓCl₍₃₋ₓ₎, or a combination thereof, wherein x is from 0.01 to 2.0. The electrolyte may contain an ionic liquid that contains an aluminum salt mixed with an organic chloride selected from n-butyl-pyridinium-chloride (BuPyCl), 1-methyl-3-ethylimidazolium-chloride (MEICl), 2-dimethyl-3-propylimidazolium-chloride, 1,4-dimethyl-1,2,4-triazolium chloride (DMTC), or a mixture thereof.

The present disclosure also provides a method of manufacturing an aluminum secondary battery. In certain embodiments, the method comprises (a) providing an anode containing aluminum metal or an aluminum alloy; (b) preparing a cathode roll by rolling or winding a layer of isolated graphene sheets and/or graphite flakes, an optional conductive additive, and an optional binder into a roll shape; wherein the isolated graphene sheets or graphite flakes are aligned or oriented perpendicular to the cathode roll thickness; (c) providing a porous or ion-permeable separator electronically separating the anode and the cathode and an electrolyte capable of supporting reversible deposition and dissolution of aluminum at the anode and reversible adsorption/desorption and/or intercalation/de-intercalation of ions at the cathode; (d) aligning and packing the anode, the cathode roll, and the separator layer between the anode and the cathode roll to form a battery cell in such a manner that the cathode roll width direction is substantially perpendicular to the separator plane and wherein the roll of aligned graphene sheets/graphite flakes is oriented in such a manner that the cathode roll has a graphene edge plane in direct contact with the electrolyte and facing or contacting the separator. The method may further comprise a sub process of impregnating the battery cell with the electrolyte.

Alternatively, the electrolyte in the cathode may be incorporated along with the graphene sheets and/or graphite flakes when these sheets or flakes are compressed or aligned to form a roll. Thus, in certain embodiments, sub process (b) of preparing a cathode roll comprises rolling or winding the layer of isolated graphene sheets/graphite flakes, optional conductive additive, optional binder, and the electrolyte into a roll shape, wherein the roll shape comprises multiple graphene sheets/graphite flakes being alternately spaced by thin electrolyte layers, less than 10 nm (preferably <5 nm) in thickness. The electrolyte may contain an aqueous electrolyte, an organic electrolyte, a molten salt electrolyte, or an ionic liquid.

The method may further include providing a porous network of electrically conductive nano-filaments to support the aluminum metal or aluminum alloy at the anode.

In certain embodiments, the procedure of providing the cathode roll includes (i) depositing multiple graphene sheets and/or graphite flakes onto one or two primary surfaces of a solid substrate, with or without the electrolyte, to form a laminate comprising at least one graphene layer; (ii) compressing the laminate to align the multiple graphene sheets and/or graphite flakes; and (iii) rolling or winding the compressed laminate into a roll shape, with or without pre-removing or separating the solid substrate from the at least one graphene or graphite layer.

The method can further include providing a porous network of electrically conductive nano-filaments to support the aluminum or aluminum alloy at the anode. The aluminum metal or aluminum alloy can be deposited onto the surfaces of these nano-filaments to form a thin coating. This can be accomplished by physical vapor deposition, sputtering, or electrochemical deposition.

### BRIEF DESCRIPTION OF THE DRAWINGS

FIG. 1(A) Schematic drawing illustrating the processes for producing intercalated and/or oxidized graphite, subsequently exfoliated graphite worms, separated graphene sheets, and paper, mat, film, and membrane of aggregated graphite flakes, graphene sheets, etc.;

FIG. 1(B) An SEM image of exfoliated carbon (exfoliated carbon worms);

FIG. 1(C) A TEM image of graphene sheets;

FIG. 2(A) Schematic of a conventional aluminum secondary battery cell.

FIG. 2(B) Schematic of part of an internal structure of a prior art cylindrical aluminum secondary battery cell, indicating the roll contains a laminated structure of an anode layer coated on an anode current collector, a porous separator, and a cathode layer coated on a cathode current collector, which is wound to form a cylindrical roll.

FIG. 2(C) Schematic drawing of a presently disclosed rolled aluminum secondary battery.

FIG. 2(D) Schematic drawing of a process for winding an anode or cathode active material-coated solid substrate around a mandrel (60 or 62) to form a cylindrical roll 58 or cuboidal roll 54.

FIG. 2(E) Schematic of a presently disclosed aluminum secondary battery containing multiple rolled cells internally connected in series (typically a bipolar current collector is disposed between two cell units).

FIG. 2(F) Schematic of a presently disclosed aluminum secondary battery containing multiple rolled cells internally connected in parallel.

FIG. 3 A process for producing layers of oriented graphene sheets and/or expanded graphite flakes; layers may be rolled up to make cathodes.

FIG. 4 The discharge curves of three Al foil anode-based cells: first one having a cathode roll of highly oriented graphene sheets (aligned perpendicular to the porous separator plane; graphene edge plane parallel to the separator plane); second one having a cathode of original graphite particles (from which graphene sheets were produced); third one the original artificial graphite.

FIG. 5 The specific capacity values of cathode rolls comprising a wide variety of lightly recompressed graphene sheets plotted as a function of the specific surface area.

FIG. 6 The specific capacity values of three Al cells plotted as a function of charge/discharge cycles: a cell containing a cathode roll of heavily recompressed graphene sheets (having an edge plane being parallel to the separator and in ionic contact with the separator), and a cell containing a cathode of original artificial graphite.

FIG. 7 The Ragone plots of three aluminum cells: a cell containing a cathode layer of original artificial graphite particles, a cell containing a cathode roll of oriented graphite flakes (edge plane parallel to the separator and contacting therewith), and a cell containing a cathode roll of oriented graphene sheets (graphene edge plane parallel to the separator and contacting therewith); the latter two were prepared via dry compression.

### DESCRIPTION OF THE PREFERRED EMBODIMENTS

The present disclosure provides a rolled aluminum secondary battery comprising an anode, a cathode, a porous or ion-permeable separator electronically separating the anode and the cathode, and an electrolyte in ionic contact with the anode and the cathode to support reversible deposition and dissolution of aluminum at the anode, wherein the anode contains aluminum metal or an aluminum metal alloy as an anode active material and the cathode contains a wound cathode roll of a cathode active material having a cathode roll length, a cathode roll width, and a cathode roll thickness, wherein the cathode active material contains isolated graphene sheets, expanded graphite flakes, recompressed exfoliated graphite worms having constituent graphite flakes that are aligned or oriented substantially parallel to a plane defined by the cathode roll length and the cathode roll width; and wherein the cathode roll width is substantially perpendicular to the separator in such a manner that the aligned or oriented graphene sheets have a graphene edge plane in direct contact with the electrolyte and facing the separator.

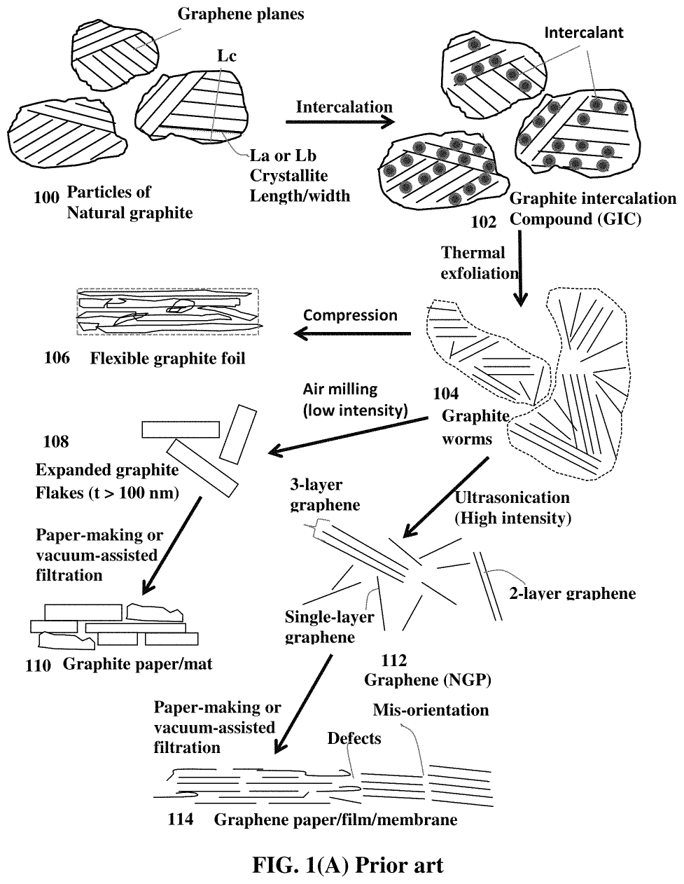

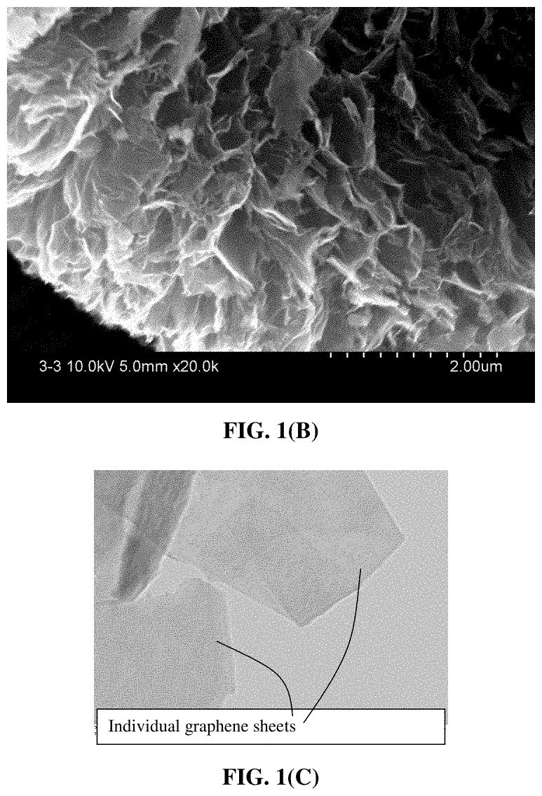

Typically, graphene is produced from graphite and, thus, it is of interest to review the role of conventional graphite as a potential cathode active material in an Al-ion cell. As schematically illustrated in the upper portion of FIG. 1(A), bulk natural graphite is a 3-D graphitic material with each graphite particle being composed of multiple grains (a grain being a graphite single crystal or crystallite) with grain boundaries (amorphous or defect zones) demarcating neighboring graphite single crystals. Each grain is composed of multiple graphene planes that are oriented parallel to one another. A graphene plane or hexagonal carbon atom plane in a graphite crystallite is composed of carbon atoms occupying a two-dimensional, hexagonal lattice. Each graphene plane has an edge and several graphene planes stacked together in a graphite crystallite can form an edge plane that is perpendicular to the graphene plane. It is through this edge plane that Al³⁺ cations and/or aluminum salt anions (e.g. AlCl₄⁻) intercalate into the inter-planar spaces between graphene planes during the discharge of the aluminum-ion cell. If the graphene plane or the edge plane is not properly or advantageously oriented, the anions and/or cations would not have good access to these inter-planar spaces. The ions must travel tortuous or much longer pathways to reach the edge plane. In some situations, these edge planes might not be accessible to the ions at all.

In a given grain or single crystal, the graphene planes are stacked and bonded via van der Waal forces in the crystallographic c-direction (perpendicular to the graphene plane or basal plane). The inter-graphene plane spacing (the “gallery”) in a natural graphite material is approximately 0.3354 nm. Theoretical calculations indicate that the sizes (gallery heights) of the AlCl₄⁻ ions or their neutral counterpart present in the inter-planar space are from 0.881 to 0.885 nm. This implies that a space of 0.3364 nm in height cannot be a favorable site for accommodating AlCl₄⁻ ions purely from the perspective of size misfit. The theoretical specific capacity, based on the intercalation of AlCl₄⁻ ions in the inter-graphene space, is approximately 70 mAh/g.

Artificial graphite materials also contain constituent graphene planes, but they have an inter-graphene planar spacing, d₀₀₂, typically from 0.32 nm to 0.36 nm (more typically from 0.3339 to 0.3465 nm), as measured by X-ray diffraction. Many carbon or quasi-graphite materials also contain graphite crystals (also referred to as graphite crystallites, domains, or crystal grains) that are each composed of stacked graphene planes. These include meso-carbon micro-beads (MCMBs), meso-phase carbon, soft carbon, hard carbon, coke (e.g. needle coke), carbon or graphite fibers (including vapor-grown carbon nano-fibers or graphite nano-fibers), and multi-walled carbon nanotubes (MW-CNT). The spacing between two graphene rings or walls in a MW-CNT is approximately 0.27 to 0.42 nm. The most common spacing values in MW-CNTs are in the range from 0.32-0.35 nm, which do not strongly depend on the synthesis method. All these inter-planar spaces fall short of the demanded height of 0.881 nm.

It may be noted that the “soft carbon” refers to a carbon material containing graphite domains wherein the orientation of the hexagonal carbon planes (or graphene planes) in one domain and the orientation in neighboring graphite domains are not too mis-matched from each other so that these domains can be readily merged together when heated to a temperature above 2,000° C. (more typically above 2,500° C.). Such a heat treatment is commonly referred to as graphitization. Thus, the soft carbon can be defined as a carbonaceous material that can be graphitized. In contrast, a “hard carbon” can be defined as a carbonaceous material that contain highly mis-oriented graphite domains that cannot be thermally merged together to obtain larger domains; i.e. the hard carbon cannot be graphitized. Both hard carbon and soft carbon contain graphite domains that can be intercalated, thermally exfoliated, and extracted/separated to form graphene sheets. The graphene sheets then can be recompressed to produce a cathode layer having graphene sheets being aligned.

The spacing between constituent graphene planes of a graphite crystallite in a natural graphite, artificial graphite, and other graphitic carbon materials in the above list can be expanded (i.e. the d₀₀₂ spacing being increased from the original range of 0.27-0.42 nm to the range of 0.42-2.0 nm) using several expansion treatment approaches, including oxidation, fluorination, chlorination, bromination, iodization, nitrogenation, intercalation, combined oxidation-intercalation, combined fluorination-intercalation, combined chlorination-intercalation, combined bromination-intercalation, combined iodization-intercalation, or combined nitrogenation-intercalation of the graphite or carbon material. Different intercalants lead to different d₀₀₂ spacing values; e.g. fluorination of natural graphite can have a d₀₀₂ spacing increased from 0.335 nm to a value of 0.39-0.6 nm.

More specifically, due to the van der Waals forces holding the parallel graphene planes together being relatively weak, natural graphite can be treated so that the spacing between the graphene planes is increased to provide a marked expansion in the c-axis direction. This results in a graphite material having an expanded spacing, but the laminar character of the hexagonal carbon layers is substantially retained. The inter-planar spacing (also referred to as inter-graphene spacing) of graphite crystallites can be increased (expanded) via several approaches, including oxidation, fluorination, and/or intercalation of graphite. The presence of an intercalant, oxygen-containing group, or fluorine-containing group serves to increase the spacing between two graphene planes in a graphite crystallite and weaken the van der Waals forces between graphene planes, enabling easier thermal exfoliation and separation of graphene sheets.

The inter-planar spaces between certain graphene planes may be significantly further increased (actually, exfoliated) if the graphite/carbon material having expanded d spacing is exposed to a thermal shock (e.g. by rapidly placing this carbon material in a furnace pre-set at a temperature of typically 800-2,500° C.) without constraint (i.e. being allowed to freely increase volume). Under these conditions, the thermally exfoliated graphite/carbon material appears like worms, wherein each graphite worm is composed of many graphite flakes remaining interconnected (please see FIG. 1(B)). However, these graphite flakes have inter-flake pores typically in the pore size range of 20 nm to 10 μm.

The graphite worms (including carbon worms) may be roll-pressed to form a roll of recompressed graphite worms having graphite flakes that are aligned or oriented. The carbon/graphite worms may be subjected to high-intensity mechanical shearing treatments to break up the worms and separate constituent graphene planes into graphene sheets. If low-intensity shearing is used, the products contain expanded graphite flakes having a thickness typically from 10 nm to 500 nm.

In one process, graphite materials having an expanded inter-planar spacing are obtained by intercalating natural graphite particles with a strong acid and/or an oxidizing agent to obtain a graphite intercalation compound (GIC) or graphite oxide (GO), as illustrated in FIG. 1(A). The presence of chemical species or functional groups in the interstitial spaces between graphene planes serves to increase the inter-graphene spacing, d₀₀₂, as determined by X-ray diffraction, thereby significantly reducing the van der Waals forces that otherwise hold graphene planes together along the c-axis direction. The GIC or GO is most often produced by immersing natural graphite powder (100 in FIG. 1(A)) in a mixture of sulfuric acid, nitric acid (an oxidizing agent), and another oxidizing agent (e.g. potassium permanganate or sodium perchlorate). The resulting GIC (102) is actually some type of graphite oxide (GO) particles if an oxidizing agent is present during the intercalation procedure. This GIC or GO is then repeatedly washed and rinsed in water to remove excess acids, resulting in a graphite oxide suspension or dispersion, which contains discrete and visually discernible graphite oxide particles dispersed in water.

Water may be removed from the suspension to obtain “expandable graphite,” which is essentially a mass of dried GIC or dried graphite oxide particles. The inter-graphene spacing, d₀₀₂, in the dried GIC or graphite oxide particles is typically in the range from 0.42-2.0 nm, more typically in the range from 0.5-1.2 nm. It may be noted than the “expandable graphite” is not “expanded graphite” (to be further explained later). Graphite oxide can have an oxygen content of 2%-50% by weight, more typically 20%-40% by weight.

There are two types of GO/GIC. Type-1 contains heavily oxidized GO or Stage-1 GIC. The oxygen content is typically 30-47% by weight; the d₀₀₂ spacing being typically 0.9-1.2 nm; the X-ray diffraction peak corresponding to d₀₀₂=0.3345 nm disappears. Stage-1 GIC is defined as the graphite intercalation compound that contains one intercalant layer for every one graphene plane. In this case, the intercalant can be sulfuric acid molecules, nitric acid molecules, H₂O₂, etc. These chemical species are there to expand the spacing between graphene planes and/or oxidize the graphene planes, forming —COOH, —OH, ═O, etc. on the planes.

Type-2 contains moderately or lightly oxidized GO or Stage-n GIC (n>1). The oxygen content is typically 5-30% by weight; the d₀₀₂ spacing being typically 0.5-0.9 nm; the X-ray diffraction peak corresponding to d₀₀₂=0.3345 nm is weak but not disappeared. Stage-n GIC is defined as the graphite intercalation compound that contains one intercalant layer for every n graphene planes.

Upon exposure of expandable graphite to a temperature in the range from typically 800-2,500° C. (more typically 900-1,050° C.) for approximately 30 seconds to 2 minutes, the CO or GIC undergoes a rapid volume expansion by a factor of 30-300 to form exfoliated and separated graphene sheets (if Type-1 GIC/GO) or “exfoliated graphite” or “graphite worms,” 104 (if Type-2). Examples of graphene sheets are shown in FIG. 1(C). Graphite worms are each a collection of exfoliated, but largely un-separated graphite flakes that remain interconnected (FIG. 1(B)). In exfoliated graphite, individual graphite flakes (each containing 1 to several hundred graphene planes stacked together) are highly spaced from one another, having a spacing of typically 20 nm-10 μm. However, they remain physically interconnected, forming an accordion or worm-like structure.

Exfoliated graphite worms can be mechanically compressed to obtain “recompressed exfoliated graphite” for the purpose of densifying the mass of exfoliated graphite worms. In some engineering applications, the graphite worms are extremely heavily compressed to form flexible graphite sheets or foils 106 that typically have a thickness in the range from 0.1 mm-0.5 mm.)

Alternatively, in graphite industry, one may choose to use a low-intensity air mill or shearing machine to simply break up the graphite worms for the purpose of producing the so-called “expanded graphite” flakes (108) which contain mostly graphite flakes or platelets thicker than 10 nm, and more typically thicker than 100 nm (hence, not a nano material by definition). It is clear that the “expanded graphite” is not “expandable graphite” and is not “exfoliated graphite worm” either. Rather, the “expandable graphite” can be thermally exfoliated to obtain “graphite worms,” which, in turn, can be subjected to mechanical shearing to break up the otherwise interconnected graphite flakes to obtain “expanded graphite” flakes. Expanded graphite flakes typically have the same or similar inter-planar spacing (typically 0.335-0.36 nm) of their original graphite. Expanded graphite is not graphene either. Expanded graphite flakes have a thickness typically greater than 100 nm; in contrast, graphene sheets typically have a thickness smaller than 10 nm, more typically less than 5 nm, and most typically less than 3.4 nm (single layer graphene is 0.34 nm thick and few-layer graphene is from 0.68 nm to 3.4 nm, containing 2-10 graphene planes).

Further alternatively, the exfoliated graphite or graphite worms may be subjected to high-intensity mechanical shearing (e.g. using an ultrasonicator, high-shear mixer, high-intensity air jet mill, or high-energy ball mill) to form separated single-layer and multi-layer graphene sheets (collectively called nano graphene platelets, NGPs, 112), as disclosed in our U.S. application Ser. No. 10/858,814 (U.S. Pat. Pub. No. 2005/0271574) (now abandoned). Single-layer graphene can be as thin as 0.34 nm, while multi-layer graphene can have a thickness up to 100 nm, but more typically less than 3 nm (commonly referred to as few-layer graphene). Multiple graphene sheets or platelets may be made into a sheet of NGP paper (114) using a paper-making process.

Graphene can be pristine graphene, graphene oxide, reduced graphene oxide, graphene fluoride, graphene chloride, graphene iodide, hydrogenated graphene, nitrogenated graphene, doped graphene (e.g. B-doped graphene), functionalized graphene, etc. The production of these graphene materials is now well-known in the art.

It may be noted that the “expandable graphite” or graphite with expanded inter-planar spacing may also be obtained by forming graphite fluoride (GF), instead of GO. Interaction of F₂ with graphite in a fluorine gas at high temperature leads to covalent graphite fluorides, from (CF)ₙ to (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents (e.g. mixtures of F₂ with Br₂, Cl₂, or I₂) may be used, although most of the available literature involves fluorination with F₂ gas, sometimes in presence of fluorides.

We have observed that lightly fluorinated graphite, CₓF (2≤x≤24), obtained from electrochemical fluorination, typically has an inter-graphene spacing (d₀₀₂) less than 0.37 nm, more typically <0.35 nm. Only when x in CₓF is less than 2 (i.e. 0.5≤x<2) can one observe a d₀₀₂ spacing greater than 0.5 nm (in fluorinated graphite produced by a gaseous phase fluorination or chemical fluorination procedure). When x in CₓF is less than 1.33 (i.e. 0.5≤x<1.33) one can observe a d₀₀₂ spacing greater than 0.6 nm. This heavily fluorinated graphite is obtained by fluorination at a high temperature (>>200° C.) for a sufficiently long time, preferably under a pressure >1 atm, and more preferably >3 atm. For reasons remaining unclear, electrochemical fluorination of graphite leads to a product having a d spacing less than 0.4 nm even though the product CₓF has an x value from 1 to 2. It is possible that F atoms electrochemically introduced into graphite tend to reside in defects, such as grain boundaries, instead of between graphene planes and, consequently, do not act to expand the inter-graphene planar spacing.

Upon exposure to heat shock, highly fluorinated graphite can directly lead to the formation of graphene fluoride sheets, one type of graphene material. Lightly or moderately fluorinated graphite, upon exposure to heat shock, result in the formation of fluorinated graphite worms, which can be subjected to mechanical shearing to produce graphene fluoride sheets.

The nitrogenation of graphene can be conducted by exposing a graphene oxide material to ammonia at high temperatures (200-400° C.). Nitrogenation may also be conducted at lower temperatures by a hydrothermal method; e.g. by sealing GO and ammonia in an autoclave and then increased the temperature to 150-250° C.

The present disclosure provides a strategy to exfoliate the graphite structure and separate individual graphene planes into single-layer or few-layer graphene sheets. The graphene sheets are then compressed and rolled up or wound to form a cathode roll comprising well-aligned or oriented graphene sheets having graphene edge planes to be substantially parallel to the separator layer and in proximity or in physical touch with the separator. This configuration facilitates fast intercalation of the ions into and out of the spaces between graphene planes. The spaces between graphene sheets are also re-compressed into a desired size range (e.g. 1.0 nm to 50 nm, preferably 2 nm to 10 nm).

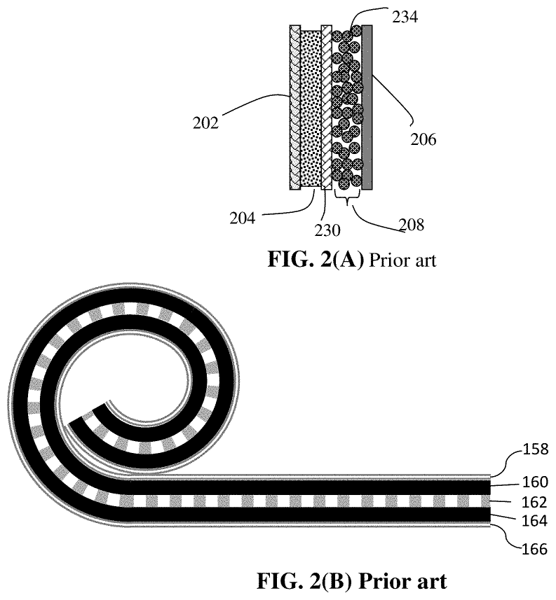

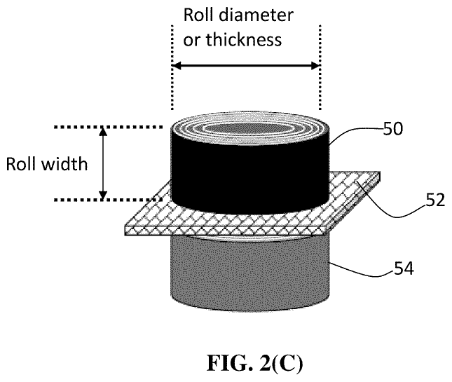

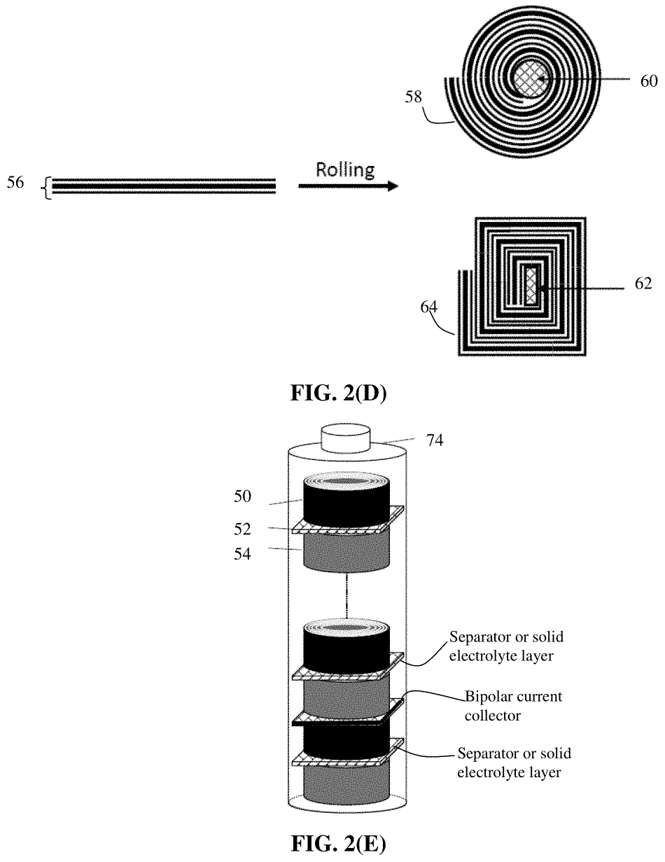

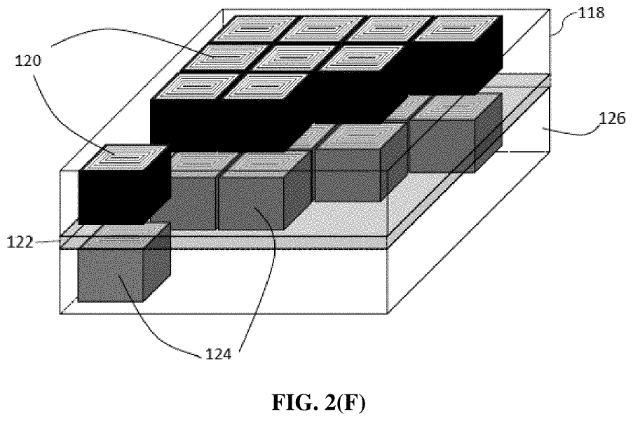

As schematically illustrated in FIG. 2(A), a prior art aluminum cell typically comprises an anode current collector 202 (e.g. Cu foil 6-10 μm thick), an anode active material layer 204 (containing an anode active material, such as an Al metal foil), a porous separator 230, a cathode active material layer 208 (containing a cathode active material, such as graphite particles 234, and conductive additives that are all bonded by a resin binder, not shown), a cathode current collector 206 (e.g. a carbon-coated Al foil), and a liquid electrolyte in ionic contact with both the anode active material layer 204 (also simply referred to as the “anode layer”) and the cathode active material layer 208 (or simply “cathode layer”). The entire cell is encased in a protective housing, such as a thin plastic-aluminum foil laminate-based envelop. The prior art aluminum cell is typically made by a process that includes the following steps:
a) The first step is mixing particles of the cathode active material (e.g. particles of natural or artificial graphite, V₂O₅, and MoS₂, etc.), a conductive filler (e.g. graphite flakes), a resin binder (e.g. PVDF) in a solvent (e.g. NMP) to form a cathode slurry.
b) The second step includes coating the cathode slurry onto one or both primary surfaces of a cathode current collector (e.g. carbon-coated stainless steel foil), drying the coated layer by vaporizing the solvent (e.g. NMP) to form a dried cathode electrode coated on a current collector foil.
c) The third step includes laminating an Al metal foil sheet, a porous separator layer, and a cathode/stainless steel foil sheet together to form a 3-layer or 5-layer assembly, which is cut and slit into desired sizes and stacked to form a rectangular structure (as an example of shape) or rolled into a cylindrical cell structure.
d) The rectangular or cylindrical laminated structure is then encased in a laminated aluminum-plastic envelope or steel casing.
e) A liquid electrolyte is then injected into the laminated housing structure to make an aluminum cell.

There are several serious problems associated with this conventional process and the resulting battery cell:
1) It is very difficult to produce an electrode layer (cathode layer) that is thicker than 100 μm and practically impossible or impractical to produce an electrode layer thicker than 200 μm using the slurry coating process. There are several reasons why this is the case. An electrode of 100 μm thickness typically requires a heating zone of at least 30-50 meters long in a slurry coating facility, which is too time consuming, too energy intensive, and not cost-effective. A heating zone longer than 100 meters is not unusual.
2) For some electrode active materials, such as graphene sheets, it has not been possible to produce an electrode thicker than 50 μm in a real manufacturing environment on a continuous basis. This is despite the notion that some thicker electrodes have been claimed in open or patent literature, which were prepared in a laboratory on a small scale. In a laboratory setting, presumably one could repeatedly add new materials to a layer and manually consolidate the layer to increase the thickness of an electrode. However, even with such a procedure, the resulting electrode becomes very fragile and brittle. This is even worse for graphene-based electrodes, since repeated compressions lead to re-stacking of graphene sheets and, hence, significantly reduced specific surface area and reduced specific capacitance.
3) With a conventional Al-ion battery, as depicted in FIG. 2(A), the actual mass loadings of the electrodes and the apparent densities for the active materials are too low. In most cases, the active material mass loadings of the electrodes (areal density) is significantly lower than 10 mg/cm² and more typically lower than 5 g/cm³. In addition, there are so many other non-active materials (e.g. conductive additive and resin binder) that add additional weights and volumes to the electrode without contributing to the cell capacity. These low areal densities result in relatively low volumetric capacities and low volumetric energy density.
4) The conventional process requires dispersing electrode active materials (anode active material and cathode active material) in a liquid solvent (e.g. NMP) to make a wet slurry and, upon coating on a current collector surface, the liquid solvent has to be removed to dry the electrode layer. Once the anode and cathode layers, along with a separator layer, are laminated together and packaged in a housing to make a battery cell, one then injects a liquid electrolyte into the cell. In actuality, one makes the two electrodes wet, then makes the electrodes dry, and finally makes them wet again. Such a wet-dry-wet process is clearly not a good process at all.

Schematically shown in FIG. 2(B) is part of an internal structure of a prior art cylindrical battery cell, indicating that each cell contains a roll, which is composed of a laminate of an anode layer 110 (e.g. an Al foil) coated on an anode current collector 108, a porous separator 112, and a cathode layer 114 coated on a cathode current collector 116. Each roll contains both the anode and the cathode active material layers therein. There is only one roll in one unit cell.

In contrast, in the presently invented rolled aluminum secondary cell (e.g. FIG. 2(C)), one unit cell contains at least two separate rolls: a cathode roll 50 and an anode roll 54, which are separated by a porous membrane or alkali metal ion-conducting separator layer 52.

In another embodiment, the anode can be in a traditional non-roll shape layer form while the cathode is in a roll shape (but this roll does not contain an anode, only the cathode, as opposed to the conventional cell that contains both the anode and the cathode in the same roll.

As schematically shown in FIG. 2(D), the anode roll may be formed by winding an anode active material-coated film or layer 56 around a mandrel with a desired cross-section shape, such as a circle 60 or a rectangle 62, to form a cylinder roll 58 or cuboid roll 64, respectively. The anode roll may be produced by laminating an Al metal foil (with the surface Al₂O₃ layer removed by chemical etching) and a Cu foil or a nano-structured porous graphene foam (as two examples of an anode current collector) and wound into a roll shape, the anode roll.

The cathode active material-coated film or layer may be a cathode active material layer-coated metal foil produced by the conventional slurry coating process. The cathode active material layer may contain a conductive additive and a resin binder. The coated film or layer may be slit/cut into a desired width (which becomes the roll width after the coated film/layer is wound into a roll). The coated layer is then rolled or wound into a cathode roll of a desired shape.

One anode roll, one sheet of porous separator, and one cathode roll may be assembled together to form one rolled battery cell, as illustrated in FIG. 2(C), wherein the roll width is perpendicular to the separator plane.

By arranging the roll layer width normal to the separator, the pore channels originally parallel to the current collector (in the conventional cell) can be aligned to facilitate the ionic conduction in the electrode layers (in a newly invented rolled cell). The present disclosure provides a rolled aluminum cell having a high roll width (corresponding to the thickness of a conventional electrode) and, thus, a high active material mass loading. The cell also has a low overhead weight and volume, high volumetric capacity, and high volumetric energy density. In addition, the manufacturing costs of the presently invented rolled aluminum cell produced by the presently invented process can be significantly lower than those by conventional processes.

The present disclosure provides a rolled aluminum cell having a high electrode layer (roll) width (no theoretical limitation on the electrode roll width that can be made by using the presently invented process), high active material mass loading (and high overall electrode mass and volume), low overhead weight and volume, high volumetric capacitance, and high volumetric energy density.

The invented rolled aluminum cell comprises an anode (in a roll form or a conventional flat layer form), a cathode roll, a porous separator electronically separating the anode and the cathode, and an electrolyte in ionic contact with the anode and the cathode. The cathode contains a wound cathode roll of an anode active material having a cathode roll length, a cathode roll width, and a cathode roll thickness (or diameter), wherein the cathode active material contains isolated graphene sheets that are oriented substantially parallel to the plane defined by the cathode roll length and the cathode roll width. The anode roll width (if in a roll form) and/or the cathode roll width is substantially perpendicular to the separator plane. The preferred orientation of graphene sheets, being normal to the separator plane, is found to be conducive to fast responses of massive charges and, thus, high power density of the resulting aluminum cell.

Typically, the rolled aluminum cell further contains an anode tab connected to or integral with the anode and a cathode tab connected to or integral with the cathode. Preferably and typically, the rolled aluminum cell further comprises a casing that encloses the anode, the cathode, the separator, and the electrolyte therein to form a sealed battery.

In some cases (herein referred to as Type-II rolled aluminum cell for convenience), the cathode roll may contain electrode active material (i.e. oriented graphene sheets) that are present alone (along with an electrolyte) without being supported on a solid or porous supporting substrate. In other cases (Type-I), the oriented graphene sheets are coated onto a solid substrate or impregnated into pores of a porous substrate, possibly along with some optional conductive additive and optional binder resin.

In these latter rolled aluminum cells (Type-I), the wound anode roll of an anode active material contains (a) a layer of supporting solid substrate (e.g. Cu foil) having two primary surfaces wherein either one or both of the primary surfaces are coated with the anode active material (e.g. Al metal), or (b) a layer of supporting porous substrate having pores that are impregnated with the anode active material (Al metal), an optional conductive additive, and an optional binder. In certain embodiments, the wound cathode roll of a cathode active material may contain (a) a layer of supporting solid substrate having two primary surfaces wherein either one or both of the primary surfaces are coated with the cathode active material (e.g. graphene sheets), an optional conductive additive, and an optional binder or (b) a layer of supporting porous substrate having pores that are impregnated with the cathode active material, an optional conductive additive, and an optional binder.

In the former cases (Type-II), the electrolyte and the isolated graphene sheets in the cathode of the invented rolled aluminum cell are assembled into an electrolyte-impregnated laminar graphene structure that is wound into an cathode roll, wherein the isolated graphene sheets are alternately spaced by thin electrolyte layers, having a thickness from 0.3 nm to 10 nm, and the laminar graphene structure has a physical density from 0.5 to 1.7 g/cm³ and a specific surface area from 50 to 3,300 m²/g, when measured in a dried state of the laminar structure with the electrolyte removed. In these cases, the electrode produced has been pre-impregnated with an electrolyte (aqueous, organic, ionic liquid, or polymer gel), wherein all graphene surfaces have been wetted with a thin layer of electrolyte (hence, no dry spots) and all graphene sheets have been well-aligned along one direction and closely packed together. The graphene sheets are alternatingly spaced with ultra-thin layers of electrolyte (0.3 nm to <10 nm, more typically <5 nm, most typically <2 nm). The process obviates the need to go through the lengthy and environmentally unfriendly wet-dry-wet procedures of the prior art process.

A particularly desirable embodiment of the present disclosure is a rolled aluminum cell (Type-II) comprising an anode current collector, an anode, a cathode, a cathode current collector, an ion-permeable separator that electronically separates the anode and the cathode, and an electrolyte in ionic contact with the anode and the cathode, wherein the cathode contains a wound roll of an electrolyte-impregnated laminar graphene structure, which comprises multiple graphene sheets being alternately spaced by thin electrolyte layers, less than 10 nm in thickness (typically from 0.3 nm to 5 nm), and the multiple graphene sheets are substantially aligned along a desired direction perpendicular to the separator, and wherein the laminar graphene structure has a physical density from 0.5 to 1.7 g/cm³ and a specific surface area from 50 to 3,300 m²/g, when measured in a dried state of the laminar graphene structure with the electrolyte removed.

As shown in FIG. 2(C), one anode roll and one cathode roll, separated by a porous separator, are assembled to form a unit cell. As illustrated in FIG. 2(F), multiple unit cells (each containing an anode roll 50, a separator 52, and a cathode roll 54) may be internally connected in series and sealed inside a casing 74 (e.g. a cylindrical stainless steel housing) to form a battery of a multiplied or significantly higher output voltage level. There is typically a bipolar current collector For instance, unit cell 1 having a voltage V₁, unit cell 2 having a voltage V₂, etc. (up to unit cell n having a voltage Vₙ) may be internally connected to form an output voltage V=V₁+V₂+ . . . +V. If V₁=V₂=V₃= . . . =Vₙ, then the overall output voltage is Vₙ=n V₁. Assume one unit battery cell has an output voltage of 2.0 volts, then one cylinder containing 6 unit cells connected in series will provide a battery output voltage of 12 volts. There is nothing in the battery industry that a cylindrical battery cell can deliver a battery voltage higher than 4.5 volts. Further, the instant disclosure enables design and construction of an aluminum battery that can have essentially any output voltage. These are some additional surprising and useful features of the presently invented rolled batteries.

It may be noted that there must be a bipolar current collector between two unit cells connected in series, although not all the bipolar current collectors are shown in the drawing to avoid crowdedness (having too many components) of the figure. Further, the electrolyte in one unit cell cannot be leaked into another cell.

Alternatively, multiple unit cells may be internally connected in parallel to form an aluminum battery that can deliver massive power and energy. A preferred and unique configuration of such an aluminum battery is illustrated in FIG. 2(F), wherein multiple cathode rolls 124 being parallel to each other are packed together to form approximately first half 126 of the massive-power aluminum battery. A corresponding pack of multiple anode rolls 120 are also arranged to be parallel to one another to form approximately the other half 118 of the aluminum battery. The two packs are then combined together, but separated by a porous separator 122, to form a complete aluminum battery. There is no theoretical limitation on the number of anode rolls or cathode rolls in such an aluminum battery. The output voltage is typically the same as the output voltage of the constituent cells (provided these unit cells are identical in composition and structure). However, the output current can be massive since there are large amounts of active materials contained in such an aluminum battery. It may be noted that the anode rolls or the cathode rolls can assume any cross-sectional shape (e.g. circular, square, rectangle, etc.) even though a square shape is shown in FIG. 2(F).

The process for producing a Type-I rolled aluminum battery may include some initial procedures commonly used to make the conventional aluminum battery, followed by additional sub processes to create the rolled electrodes. The first sub process is mixing isolated graphene sheets, an optional conductive filler (e.g. graphite flakes), a resin binder (e.g. PVDF) in a solvent (e.g. NMP) to form a cathode slurry.

The second sub process includes coating the anode slurry onto one or both primary surfaces of a cathode current collector (e.g. carbon-coated Al foil or Ni foam), drying the coated layer by vaporizing the solvent (e.g. NMP) to form a dried cathode electrode coated on carbon-coated Al foil or Ni foam to form a two-layer or three-layer cathode layer structure. The cathode layer structure is then wound into a roll shape to form an anode roll. The anode may be produced by laminating a film of Al metal and a Cu foil to form a two-layer structure, as an example. Alternatively, a nano-structure graphene foam or Ni foam may be impregnated with aluminum metal electrochemically. The resulting structure is then wound into a roll shape to form an anode roll. The rolls may be cut and slit into desired sizes and shapes as desired.

The third sub process includes assembling an anode roll, a porous separator layer, and a cathode roll to form an aluminum cell assembly, which is then encased in a laminated aluminum-plastic envelope or steel casing. A liquid electrolyte is then injected into the laminated housing structure, which is then sealed to make a rolled aluminum cell.

Alternatively, for the production of a Type-II rolled aluminum cell, the process begins with the production of an electrolyte-impregnated laminar graphene structure, which is then wound into a roll shape for use as an aluminum cell cathode. In a preferred embodiment, the process comprises: (a) preparing a graphene dispersion having multiple isolated graphene sheets dispersed in a liquid or gel electrolyte; and (b) subjecting the graphene dispersion to a forced assembly procedure, forcing the multiple graphene sheets to assemble into the electrolyte-impregnated laminar graphene structure, wherein the multiple graphene sheets are alternately spaced by thin electrolyte layers, less than 10 nm (preferably <5 nm) in thickness, and the multiple graphene sheets are substantially aligned along a desired direction, and wherein the laminar graphene structure has a physical density from 0.5 to 1.7 g/cm³ (more typically 0.7-1.3 g/cm³) and a specific surface area from 50 to 3,300 m²/g (50 to 2,630 m²/g, if the graphene sheets are not chemically activated), when measured in a dried state of the laminar structure with the electrolyte removed.

In some desired embodiments, the forced assembly procedure includes preparing a graphene dispersion, which contains isolated graphene sheets well-dispersed in a liquid or gel electrolyte. In this dispersion, practically each and every isolated graphene sheet is surrounded by electrolyte species that are physically adsorbed to or chemically bonded to the graphene surface. During the subsequent consolidating and aligning operation, isolated graphene sheets remain isolated or separated from one another through electrolyte (electrolyte serving as a spacer that prevents contacting and re-stacking of graphene sheets). Upon removal of the excess electrolyte, graphene sheets remain spaced apart by electrolyte and this electrolyte-filled space can be as small as 0.3 nm (typically 0.3 nm to 2 nm, but can be larger). There is no longer any electrolyte entry issue (that could occur in the conventional electrode) since the graphene sheets have been pre-wetted with electrolyte. In other words, since the electrolyte has been pre-loaded into the spaces between isolated graphene sheets, there is no electrolyte inaccessibility issue in the presently invented aluminum cell. The present disclosure has essentially overcome all the significant, longstanding shortcomings of using graphene as a battery or supercapacitor electrode active material.

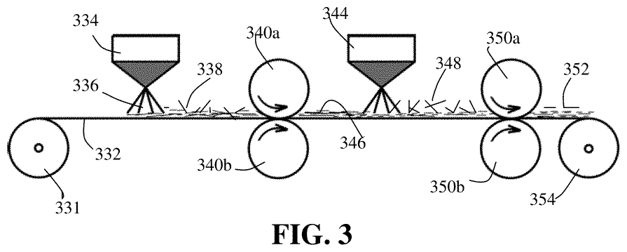

FIG. 3 shows a roll-to-roll process for producing a layer of electrolyte-impregnated laminar graphene structure. This process begins by feeding a continuous solid substrate 332 (e.g. PET film or stainless steel sheet) from a feeder roller 331. A dispenser 334 is operated to dispense dispersion 336 of isolated graphene sheets and electrolyte onto the substrate surface to form a layer of deposited dispersion 338, which feeds through the gap between two compressing rollers, 340a and 340b, to form a layer of electrolyte-impregnated, highly oriented graphene sheets. The graphene sheets are well-aligned on the supporting substrate plane. If so desired, a second dispenser 344 is then operated to dispense another layer of dispersion 348 on the surface of the previously consolidated dispersion layer. The two-layer structure is then driven to pass through the gap between two roll-pressing rollers 350a and 350b to form a thicker layer 352 of electrolyte-impregnated laminar graphene structure, which is taken up by a winding roller 354. In certain embodiments, one can unwind the layer of electrolyte-impregnated laminar graphene structure, peel off from the PET film, wound into a roll shape, and cut/slit the roll into individual rolls of desired length and wide. If PET film is replaced with a conducting material film (e.g. carbon-coated Al foil) as a current collector, then one would not need to separate the current collector. The laminated film can be wound/cut into electrode rolls of desired shape and dimensions.

Thus, in some preferred embodiments, the forced assembly procedure includes introducing a first layer of the graphene dispersion onto a surface of a supporting conveyor and driving the layer of graphene suspension supported on the conveyor through at least a pair of pressing rollers to reduce the thickness of the graphene dispersion layer and align the multiple graphene sheets along a direction parallel to the conveyor surface for forming a layer of electrolyte-impregnated laminar graphene structure.

If necessary, the process may further include a sub process of introducing a second layer of the graphene dispersion onto a surface of the layer of electrolyte-impregnated laminar structure to form a two layer laminar structure, and driving the two-layer laminar structure through at least a pair of pressing rollers to reduce a thickness of the second layer of graphene dispersion and align the multiple graphene sheets along a direction parallel to the conveyor surface for forming a layer of electrolyte-impregnated laminar structure. The same procedure may be repeated by allowing the conveyor to move toward a third set of pressing rollers, depositing additional (third) layer of graphene dispersion onto the two-layer structure, and forcing the resulting 3-layer structure to go through the gap between the two rollers in the third set to form a further compacted, electrolyte-impregnated laminar graphene structure.

The above paragraphs about FIG. 3 are but one of the many examples of possible apparatus or processes that can be adapted to produce electrolyte-impregnated laminar graphene strictures that contain highly oriented and closely packed graphene sheets spaced by thin layers of electrolyte. The conventional paper-making procedures may also be adapted to produce electrolyte-impregnated graphene paper, which is then compressed or roll-pressed between a pair of two rollers to produce the electrolyte-impregnated laminar graphene structure containing highly oriented graphene sheets (being oriented along the laminar plane). This structure is then wound into a roll shape to produce an electrode roll, which now contains graphene sheets oriented on the plane defined by the roll length and roll width and perpendicular to the roll thickness.

Thus, the present disclosure also provides a wet process for producing an electrolyte-impregnated, oriented graphene sheets for use as an aluminum battery cathode layer. In a preferred embodiment, the wet process (method) comprises: (a) preparing a dispersion or slurry having graphene sheets dispersed in a liquid or gel electrolyte; (b) subjecting the suspension to a forced assembly procedure, forcing the graphene sheets to assemble into a layer of the electrolyte-impregnated graphene sheet structure, wherein electrolyte resides in the inter-graphene spaces in the structure of oriented graphene sheets; and (c) winding the layer into a roll shape. The graphene sheets are substantially aligned along a desired direction. The rolled graphene sheet structure has a physical density from 0.5 to 1.7 g/cm³ (more typically 0.7-1.3 g/cm³) and a specific surface area from 20 to 1,500 m²/g, when measured in a dried state without the electrolyte.

The configuration of an aluminum secondary battery is now discussed as follows:

An aluminum secondary battery includes a positive electrode (cathode), a negative electrode (anode), and an electrolyte typically including an aluminum salt and a solvent. The anode can be a thin foil or film of aluminum metal or aluminum metal alloy (e.g. left-hand side of FIG. 2(A)). The anode can be composed of particles, fibers, wires, tubes, or discs of Al metal or Al metal alloy that are packed and bonded together by a binder (preferably a conductive binder) to form an anode layer.

A desirable anode layer structure is composed of a network of electron-conducting pathways (e.g. mat of graphene sheets, carbon nano-fibers, or carbon-nanotubes) and a thin layer of aluminum metal or alloy coating deposited on surfaces of this conductive network structure. Such an integrated nano-structure may be composed of electrically conductive nanometer-scaled filaments that are interconnected to form a porous network of electron-conducting paths comprising interconnected pores, wherein the filaments have a transverse dimension less than 500 nm. Such filaments may comprise an electrically conductive material selected from the group consisting of electro-spun nano fibers, vapor-grown carbon or graphite nano fibers, carbon or graphite whiskers, carbon nano-tubes, nano-scaled graphene platelets, metal nano wires, and combinations thereof. Such a nano-structured, porous supporting material for aluminum can significantly improve the aluminum deposition-dissolution kinetics, enabling high-rate capability of the resulting aluminum secondary cell.

Illustrated in FIG. 2(A) is a schematic of a prior art aluminum secondary battery, wherein the anode layer is a thin Al coating or Al foil and the cathode active material layer contains a layer of graphene sheets. Alternatively, an aluminum secondary battery cell may contain an anode layer composed of a thin coating of aluminum metal or aluminum alloy supported on surfaces of a network of conductive filaments and the cathode active material layer contains a layer of graphene sheets.

As illustrated in FIG. 2(C), according to an embodiment of the instant disclosure, the aluminum cell comprises one anode roll and one cathode roll, separated by a porous separator. The anode roll may simply comprise a roll of laminated Cu foil/Al metal foil. Alternatively, the anode roll may comprise a layer composed of a thin coating of aluminum metal or aluminum alloy supported on surfaces of a network of conductive filaments that is wound into a roll shape. In both cases, the layer of oriented graphene sheets is wound into a cathode roll, wherein the graphene sheets are aligned and implemented in such a manner that the graphene sheets have a graphene edge plane facing the separator and substantially parallel to the separator layer. In this configuration, graphene sheets are perpendicular to the separator plane and thin layers of electrolyte are also perpendicular to the separator plane. These electrolyte layers form fast-transport channels for aluminum cations (e.g. A1³⁺) and lithium salt anions (e.g. AlCl₄⁻, Al₂Cl₇⁻, EMI+ or 1-ethyl-3-methylimidazolium ions, etc.).

The composition of the electrolyte, which functions as an ion-transporting medium for charge-discharge reaction, has a great effect on battery performance. To put aluminum secondary batteries to practical use, it is necessary to allow aluminum deposition-dissolution reaction to proceed smoothly and sufficiently even at relatively low temperature (e.g., room temperature). In conventional aluminum secondary batteries, however, aluminum deposition-dissolution reaction can proceed smoothly and sufficiently only at relatively high temperature (e.g., 50° C. or higher), and the efficiency of the reaction is also low. The electrolyte for use in an aluminum secondary battery can include an aluminum salt, alkyl sulfone, and a solvent with a dielectric constant of 20 or less so that the electrolyte can operate at a lower temperature (e.g. room temperature) at which aluminum deposition-dissolution reaction proceeds.

Aqueous electrolytes that can be used in the aluminum secondary batteries include aluminum salts dissolved in water; for instance, AlCl₃-6H₂O, CrCl₃-6H₂O, and Al(NO₃)₃ in water. Alkaline solutions, such as KOH and NaOH in water, may also be used.

Organic electrolytes for use in aluminum secondary batteries include various electrolytes with g-butyrolactone (BLA) or acetonitrile (ACN) as solvent; e.g. AlCl₃/KCl salts in BLA or (C₂H₅)₄NClxH₂O (TEAC) in ACN. Also included are concentrated aluminum triflate-based electrolyte, a bath of aluminum chloride and lithium aluminum hydride dissolved in diethyl ether, and LiAlH₄ and AlCl₃ in tetrahydrofuran. For example, alkyl sulfone such as dimethylsulfone may be used, along with an organic solvent such as a cyclic or chain carbonate or a cyclic or chain ether can be used. In order to reduce polarization during discharge, an aluminum salt such as aluminum chloride and an organic halide such as trimethylphenyl-ammonium chloride may be used together in the electrolyte. For this salt mixture, an organic solvent such as 1,2-dichloroethane may be used.

Another type of electrolyte capable of reversible aluminum electrochemistry is molten salt eutectics. These are typically composed of aluminum chloride, sodium chloride, potassium chloride and lithium chloride in some molar ratio. Useful molten salt electrolytes include AlCl₃—NaCl, AlCl₃—(LiCl—KCl), and AlCl₃—KCl—NaCl mixtures. Among these alkali chloroaluminate melts, binary NaCl—AlCl₃ and ternary NaCl—KCl—AlCl₃ systems are the most widely used molten salts for developing aluminum batteries. In these systems the melts with molar ratio of MCl/AlCl₃ (where M is commonly Na and/or K) larger than unity are defined as basic, whereas those with molar ratio less than unity as acidic. In an acidic melt, Al₂Cl₇ is the major anion species. As the acidity (AlCl₃ content) of the melt decreases, AlCl₄⁻ becomes the major species.

A special class of molten salt for use in an aluminum secondary battery is room temperature molten salts (ionic liquids). For instance, a useful ionic liquid electrolyte solution is aluminum chloride mixed in 1-ethyl-3-methylimidazolium chloride (AlCl₃:EMIC). Commercially available 1-ethyl-3-methylimidazolium chloride may be purified by recrystallization from ethyl acetate and acetonitrile. Aluminum chloride may be further purified by triple sublimation. The ionic liquid may be prepared by slowly mixing molar equivalent amounts of both salts. Further, AlCl₃ was then added to the equimolar mix until a concentration of 1M AlCl₃ was obtained. Desirably, this concentration corresponds to a molar ratio of 1.2:1, AlCl₃:EMIC.

Aluminum chloride (AlCl₃) also forms room temperature electrolytes with organic chlorides, such as n-butyl-pyridinium-chloride (BuPyCl), 1-methyl-3-ethylimidazolium-chloride (MEICl), and 2-dimethyl-3-propylimidazolium-chloride. The molten mixture of 1,4-dimethyl-1,2,4-triazolium chloride (DMTC) and AlCl₃ may also be used as the secondary battery electrolyte.

This disclosure is also directed at the cathode active layer (positive electrode layer) containing a high-capacity cathode material for the aluminum secondary battery. The disclosure also provides such a battery based on an aqueous electrolyte, a non-aqueous electrolyte, a molten salt electrolyte, a polymer gel electrolyte (e.g. containing an aluminum salt, a liquid, and a polymer dissolved in the liquid), an ionic liquid electrolyte, or a combination thereof. The shape of an aluminum secondary battery can be cylindrical, square, button-like, etc. The present disclosure is not limited to any battery shape or configuration.

The following examples are used to illustrate some specific details about the best modes of practicing the instant disclosure and should not be construed as limiting the scope of the disclosure.

### Example 1: Oxidation of Graphite and Thermal Exfoliation of Oxidized Graphite

Natural flake graphite, nominally sized at 45 μm, provided by Asbury Carbons (405 Old Main St., Asbury, N.J. 08802, USA) was milled to reduce the size to approximately 14 μm (Sample 1a). The chemicals used in the present study, including fuming nitric acid (>90%), sulfuric acid (95-98%), potassium chlorate (98%), and hydrochloric acid (37%), were purchased from Sigma-Aldrich and used as received. Graphite oxide (GO) samples were prepared according to the following procedure:

Sample 1A: A reaction flask containing a magnetic stir bar was charged with sulfuric acid (176 mL) and nitric acid (90 mL) and cooled by immersion in an ice bath. The acid mixture was stirred and allowed to cool for 15 min, and graphite (10 g) was added under vigorous stirring to avoid agglomeration. After the graphite powder was well dispersed, potassium chlorate (110 g) was added slowly over 15 min to avoid sudden increases in temperature. The reaction flask was loosely capped to allow evolution of gas from the reaction mixture, which was stirred for 24 hours at room temperature. On completion of the reaction, the mixture was poured into 8 L of deionized water and filtered. The GO was re-dispersed and washed in a 5% solution of HCl to remove sulfate ions. The filtrate was tested intermittently with barium chloride to determine if sulfate ions are present. The HCl washing step was repeated until this test was negative. The GO was then washed repeatedly with deionized water until the pH of the filtrate was neutral. The GO slurry was spray-dried and stored in a vacuum oven at 60° C. until use.

Sample 1B: The same procedure as in Sample 1A was followed, but the reaction time was 48 hours.

Sample 1C: The same procedure as in Sample 1A was followed, but the reaction time was 96 hours.

X-ray diffraction studies showed that after a treatment of 24 hours, a significant proportion, but not all, of graphite has been transformed into graphite oxide. The peak at 2θ=26.3 degrees, corresponding to an inter-planar spacing of 0.335 nm (3.35 Å) for pristine natural graphite was significantly reduced in intensity after a deep oxidation treatment for 24 hours and a peak typically near 2°=9-14 degrees (depending upon degree of oxidation) appeared. In the present study, the curves for treatment times of 48 and 96 hours are essentially identical, showing that essentially all of the graphite crystals have been converted into graphite oxide with an inter-planar spacing of 6.5-7.5 Å (the 26.3 degree peak has totally disappeared and a peak of approximately at 2°=11.75-13.7 degrees appeared).

Samples 1A, 1B, and 1C were then subjected to unconstrained thermal exfoliation (1,050° C. for 2 minutes) to obtain exfoliated graphite worms. Some of the graphite worms were then subjected to low-intensity and high-intensity airjet milling to obtain expanded graphite flakes and graphene sheets, respectively. The graphite worms, expanded graphite flakes, and graphene sheets, separately or in combinations, were compressed into layers of oriented graphene/graphite sheets having physical density ranging from approximately 0.5 to 1.75 g/cm³, using both dry compression and wet compression procedures. These layers were then wound into roll shapes.

For instance, a certain portion of the RGO sheets was directly dispersed in an intended liquid electrolyte to form a dispersion. Part of the dispersion was compressed and consolidated into a layer of electrolyte-impregnated, compacted and highly oriented graphene sheets (electrolyte-impregnated laminar graphene structure) according to the process illustrated in FIG. 3. This was bonded to a current collector (Al foil) with the graphene sheets aligned parallel to the Al foil plane. This two-layer structure was wound into a roll shape for use in a Type-I rolled aluminum cell. Other part of the dispersion was made into a layer of electrolyte-impregnated laminar graphene structure having aligned graphene sheets, but this layer was then peeled off from the current collector. The layer of electrolyte-impregnated laminar graphene structure was wound into a roll shape for use in a Type-II rolled aluminum cell. Similar procedures were followed to prepare rolls of recompressed graphite worms and expanded graphite flakes.

### Example 2: Oxidation, Intercalation and Thermal Exfoliation of Various Graphitic Carbon and Graphite Materials

Samples 2A, 2B, 2C, and 2D were prepared according to the same procedure used for Sample 1B, but the starting graphite materials were pieces of highly oriented pyrolytic graphite (HOPG), graphite fiber, graphitic carbon nano-fiber, and spheroidal graphite, respectively. After the expansion treatment, their final inter-planar spacings are 6.6 Å, 7.3 Å, 7.3 Å, and 6.6 Å, respectively. They were subsequently thermally exfoliated to obtain exfoliated graphite worms. Some of the graphite worms were mechanically sheared (using a household food processor) to obtain expanded graphite flakes. Some graphite worms were dispersed in water and then ultrasonicated to separate/isolate graphene sheets. These materials were separately recompressed and rolled to obtain rolls of oriented graphite flakes or graphene sheets. Physical densities, specific surface areas, and degrees of orientation were varied to produce different rolls.

### Example 3: Preparation of Graphite Oxide (GO) Using a Modified Hummers' Method and Subsequent Thermal Exfoliation

Graphite oxide (Sample 3A) was prepared by oxidation of natural graphite flakes with sulfuric acid, sodium nitrate, and potassium permanganate according to the method of Hummers [U.S. Pat. No. 2,798,878, Jul. 9, 1957]. In this example, for every 1 gram of graphite, we used a mixture of 22 ml of concentrated sulfuric acid, 2.8 grams of potassium permanganate, and 0.5 grams of sodium nitrate. The graphite flakes were immersed in the mixture solution and the reaction time was approximately one hour at 35° C. It is important to caution that potassium permanganate should be gradually added to sulfuric acid in a well-controlled manner to avoid overheat and other safety issues. Upon completion of the reaction, the mixture was poured into deionized water and filtered. The sample was then washed repeatedly with deionized water until the pH of the filtrate was approximately 5. Some of the GO-water suspension was subjected to tip-ultrasonication for 30 minutes to obtain GO sheets that are substantially single-layer species. Separately, some of the suspension was spray-dried and stored in a vacuum oven at 60° C. for 24 hours. The interlayer spacing of the resulting laminar graphite oxide was determined by the Debye-Scherrer X-ray technique to be approximately 0.73 nm (7.3 Å). Some of the powder was subsequently exfoliated in a furnace, pre-set at 650° C., for 1.5 minutes to obtain exfoliated graphite worms.

The GO sheets and exfoliated graphite worms were then made into roll shape cathode electrodes and aluminum cells using both the presently invented processes (as illustrated in FIG. 3) and the conventional production process (preparation of NMP-GO slurry, coating, drying, cell lamination, and electrolyte injection).

### Example 4: Oxidation and Thermal Exfoliation of Meso-Carbon Micro-Beads (MCMBs)

Oxidized carbon beads (Sample 4A) were prepared by oxidation of meso-carbon micro-beads (MCMBs) according to the same procedure used in Example 3. MCMB microbeads (Sample 4a) were supplied by China Steel Chemical Co. This material has a density of about 2.24 g/cm³; an average particle of 16 microns and an inter-planar distance of about 0.336 nm. After deep oxidation/intercalation treatment, the inter-planar spacing in the resulting graphite oxide micro-beads is approximately 0.76 nm. The treated MCMBs were then thermally exfoliated at 900° C. for 2 minutes to obtain exfoliated carbon, which also showed a worm-like appearance (herein referred to as “exfoliated carbon”, “carbon worms,” or “exfoliated carbon worms”). The carbon worms were then airjet-milled to form graphene sheets and roll-pressed to different extents to obtain rolls of recompressed graphene sheets having different densities, specific surface areas, and degrees of orientation.

### Example 5: Bromination and Fluorination of Carbon Fibers and Thermal Exfoliation

Graphitized carbon fiber (Sample 5a), having an inter-planar spacing of 3.37 Å (0.337 nm) and a fiber diameter of 10 μm was first halogenated with a combination of bromine and iodine at temperatures ranging from 75° C. to 115° C. to form a bromine-iodine intercalation compound of graphite as an intermediate product. The intermediate product was then reacted with fluorine gas at temperatures ranging from 275° C. to 450° C. to form the CF_{y}. The value of y in the CF_{y} samples was approximately 0.6-0.9. X-ray diffraction curves typically show the co-existence of two peaks corresponding to 0.59 nm and 0.88 nm, respectively. Sample 5A exhibits substantially 0.59 nm peak only and Sample 5B exhibits substantially 0.88 nm peak only. Some of powders were thermally exfoliated, mechanically sheared to separate/isolate graphene sheets, re-compressed, and rolled to obtain roll electrodes of oriented, recompressed graphene bromide sheets.

### Example 6: Fluorination and Thermal Exfoliation of Carbon Fibers

A CF_{0.68} sample obtained in EXAMPLE 5 was exposed at 250° C. and 1 atmosphere to vapors of 1,4-dibromo-2-butene (BrH₂C—CH═.CH—CH₂Br) for 3 hours. It was found that two-thirds of the fluorine was lost from the graphite fluoride sample. It is speculated that 1,4-dibromo-2-butene actively reacts with graphite fluoride, removing fluorine from the graphite fluoride and forming bonds to carbon atoms in the graphite lattice. The resulting product (Sample 6A) is mixed halogenated graphite, likely a combination of graphite fluoride and graphite bromide. Some of powders were thermally exfoliated to obtain exfoliated carbon fibers, which were then mechanically sheared and roll-pressed to obtain a roll structure of oriented graphene fluoride sheets.

### Example 7: Fluorination and Thermal Exfoliation of Graphite

Natural graphite flakes, a sieve size of 200 to 250 mesh, were heated in vacuum (under less than 10⁻² mmHg) for about 2 hours to remove the residual moisture contained in the graphite. Fluorine gas was introduced into a reactor and the reaction was allowed to proceed at 375° C. for 120 hours while maintaining the fluorine pressure at 200 mmHg. This was based on the procedure suggested by Watanabe, et al. disclosed in U.S. Pat. No. 4,139,474. The powder product obtained was black in color. The fluorine content of the product was measured as follows: The product was burnt according to the oxygen flask combustion method and the fluorine was absorbed into water as hydrogen fluoride. The amount of fluorine was determined by employing a fluorine ion electrode. From the result, we obtained a GF (Sample 7A) having an empirical formula (CF_{0.75})ₙ. X-ray diffraction indicated a major (002) peak at 2°=13.5 degrees, corresponding to an inter-planar spacing of 6.25 Å. Some of the graphite fluoride powder was thermally exfoliated to form graphite worms, which were then mechanically sheared to separate/isolate graphene sheets and then roll-pressed.

Sample 7B was obtained in a manner similar to that for Sample 7A, but at a reaction temperature of 640° C. for 5 hours. The chemical composition was determined to be (CF_{0.93})ₙ. X-ray diffraction indicated a major (002) peak at 2°=9.5 degrees, corresponding to an inter-planar spacing of 9.2 Å. Some of the graphite fluoride powder was thermally exfoliated to form graphite worms, which were then mechanically sheared and roll-pressed to produce a roll sheet of recompressed, oriented graphene sheets.

### Example 8: Preparation of Pristine Graphene (0% Oxygen) and Electrodes

Recognizing the possibility of the high defect population in GO sheets acting to reduce the conductivity of individual graphene plane, we decided to study if the use of pristine graphene sheets (non-oxidized and oxygen-free, non-halogenated and halogen-free, etc.) can lead to a graphene electrode having a higher electrical conductivity and lower equivalent series resistance. Pristine graphene sheets were produced by using the direct ultrasonication process (also called the liquid-phase exfoliation process).

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements. The pristine graphene sheets were then made into electrodes and rolled aluminum cells using the presently invented processes (as illustrated in FIG. 3). The conventional production process (preparation of NMP-graphene slurry, coating, drying, cell lamination, and electrolyte injection) was also followed to produce conventional (non-rolled) cells for comparison.

### Example 9: Preparation and Testing of Various Aluminum Cells

The graphene sheets and expanded graphite flakes, separately and in combinations (mixtures thereof), prepared in Examples 1-8 were made into cathode rolls and incorporated into an aluminum secondary battery. Two types of Al anode were prepared. One was Al foil having a thickness from 16 μm to 300 μm. The other was Al thin coating deposited on surfaces of conductive nano-filaments (e.g. CNTs) or graphene sheets that form an integrated 3D network of electron-conducting pathways having pores and pore walls to accept Al or Al alloy (e.g. graphene foam). Either the Al foil itself or the integrated 3D nano-structure also serves as the anode current collector.

Cyclic voltammetry (CV) measurements were carried out using an Arbin electrochemical workstation at a typical scanning rate of 0.5-50 mV/s. In addition, the electrochemical performances of various cells were also evaluated by galvanostatic charge/discharge cycling at a current density from 50 mA/g to 10 Å/g. For long-term cycling tests, multi-channel battery testers manufactured by LAND were used.

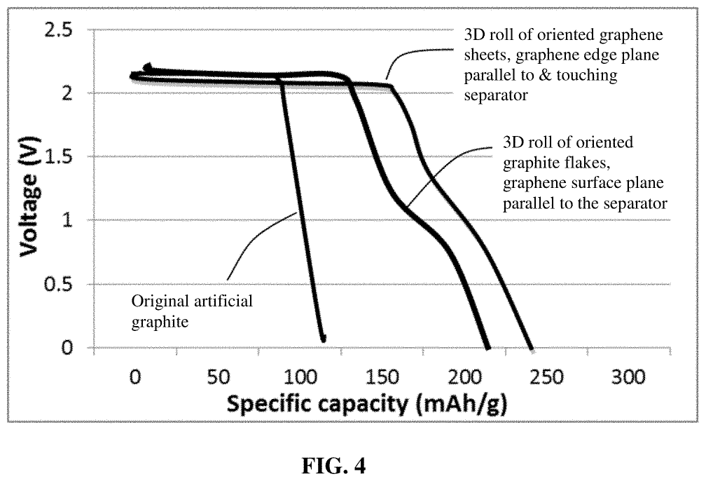

FIG. 4 shows the discharge curves of three Al foil anode-based cells: first one having a cathode roll of highly oriented graphene sheets (aligned perpendicular to the porous separator plane; graphene edge plane parallel to the separator plane) having a specific surface area (SSA)=55 m²/g; second one having a cathode roll of highly oriented graphite flakes (aligned perpendicular to the porous separator plane; graphene edge plane of the flakes being parallel to the separator plane) having a specific surface area (SSA)=11 m²/g), and third one having cathode of original graphite particles (from which graphene sheets or graphite flakes were produced). The electrolyte used was aluminum chloride mixed in 1-ethyl-3-methylimidazolium chloride (AlCl₃:EMIC molar ratio=3.5/1). These data indicate that the three battery cells all exhibit an initial plateau voltage, but the length of this plateau varied with different treatments. The cathode roll containing highly oriented graphene sheets (aligned perpendicular to the porous separator plane, having graphene edge plane parallel to the separator plane) exhibits the longest plateau; this mechanism quite likely corresponds to intercalation of A1³⁺, AlCl₄⁻, and/or Al₂Cl₇⁻ ions into the nano pores or interstitial spaces between graphene sheets, further explained below:

In the discharge process, Al metal is oxidized and released from Al foil to form Al³⁺ ions. Under the influence of the electric field, Al³⁺ ions move to the cathode side. Then, Al³⁺ ions and aluminum chloride coordination anions [AlₐCl_{b}]⁻ can simultaneously intercalate into the graphene layers, forming AlₓCl_{y}. The intercalated AlₓCl_{y} and neighboring graphene layers interact with each other by van der Waals' forces. During the charge process, the electrochemical reactions are reversed.

In the ionic liquid-based electrolyte, the existing coordination ions are AlCl₄⁻ or Al₂Cl₇⁻, and thus the intercalated coordination ion [AlₐCl_{b}]⁻ might be AlCl₄⁻ or Al₂Cl₇⁻ or a mixture thereof. Based on the above assumption, the electrode reactions for both the anode and cathode may be described as follows:

In the charge process,

Al³⁺+3e⁻→Al (anode) (1)

AlₓCl_{y}−e⁻→Al³⁺+[AlₐCl_{b}]⁻ (cathode) (2)

At the anode, during battery charging, Al₂Cl₇⁻ ions can react with electrons to form AlCl₄⁻ anions and Al. At the cathode, desorption of EMI⁺ ions from graphite surfaces may also occur.

In the discharge process,

Al−3e⁻→Al³⁺(anode) (3)

Al³⁺+[AlₐCl_{b}]⁻+e⁻→AlₓCl_{y} (cathode) (4)

It appears that the strategy of heavily recompressing the graphene sheets can result in the inter-planar spaces between graphene planes to become smaller than 20 nm, preferably and typically smaller than 10 nm (having the inter-graphene pores <10 nm) enables massive amounts of the ions to “intercalate” into these confined spaces at a reasonably high voltage (2.2 vs. Al/A1³⁺). Such an intercalation at a relatively high voltage over a long plateau range (large specific capacity, up to 150-350 mAh/g, depending on pore sizes) implies a high specific energy value (obtained by integrating the voltage curve over the specific capacity range) based on the cathode active material weight.

In addition to the intercalation of Al³⁺, AlCl₄⁻, and/or Al₂Cl₇⁻ ions, there are graphene surface areas that are accessible to liquid electrolyte and the surfaces would become available for ion adsorption/desorption and/or surface redox reactions, leading to supercapacitor-type behaviors (electric double layer capacitance, EDLC, or redox pseudo-capacitance). This behavior is responsible for the slopping voltage curve after an initial plateau regime.

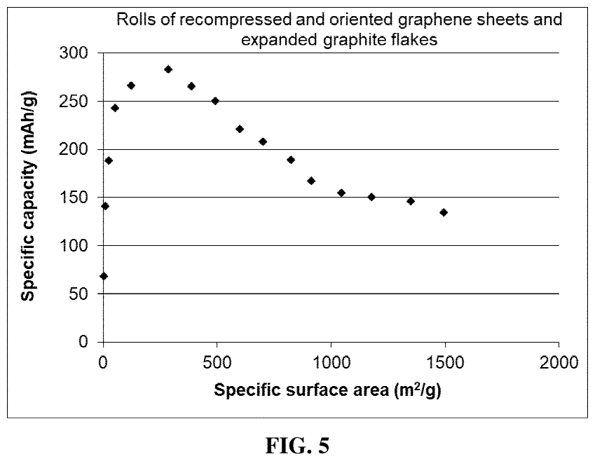

We have observed that the plateau regime totally disappears when the graphene sheets are lightly recompressed to exhibit a SSA that exceeds approximately 600 m²/g. FIG. 5 indicates that heavy recompression (as reflected by a low specific surface area) and graphene edge plane orientation lead to very high specific capacity of the cathode roll of recompressed graphene sheets having an edge plane aligned parallel to the separator and facing the separator. It seems that recompression tends to reduce the inter-graphene spaces down to 2-20 nm range, enabling an intercalation/de-intercalation type charge storage mechanism, and that the graphene sheet edges, if properly oriented, enable easier/faster and full entry of ions into inter-graphene spaces.

In summary, the charge or discharge of the invented cathode roll can involve several charge storage mechanisms. Not wishing to be bound by theory, but we believe that the main mechanisms at the cathode during battery charging are (1) desorption of EMI⁺ ions from graphene surfaces, (2) de-intercalation by Al³⁺ and AlCl₄⁻ from the inter-planar spaces, and (3) desorption of AlCl₄⁻ and Al₂Cl₇⁻ ions from graphene sheet surfaces. At the anode, during battery charging, Al₂Cl₇⁻ ions can react with electrons to form AlCl₄⁻ anions and Al, wherein AlCl₄⁻ anions move toward the cathode and Al deposits on Al foil or surface of the anode current collector. The Al³⁺ ions released from the cathode may also react with electrons to form Al metal atoms that re-deposit onto Al foil surface or the surface of an anode current collector. Some EMI⁺ ions may form electric double layers near the anode surfaces. The above processes are reversed when the battery is discharged. Different mechanisms can dominate in different regimes of the charge-discharge curves for the cathodes having different amounts of controlled interstitial spaces (2-20 nm) and inter-graphene pores (20 nm-100 nm) prepared by different procedures (different extents of recompression).

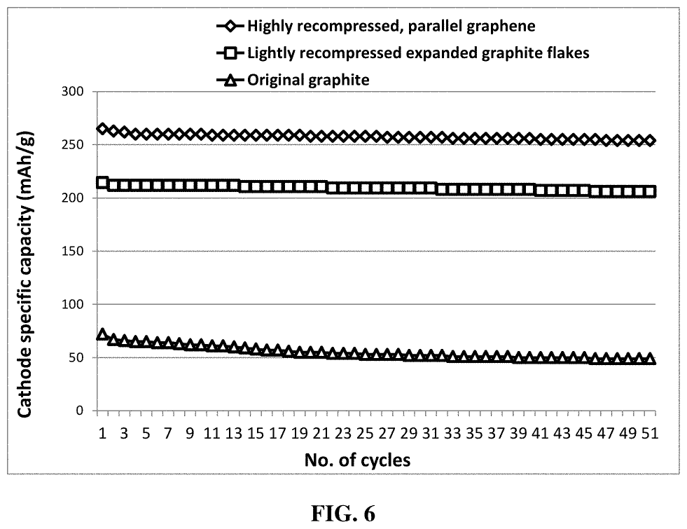

FIG. 6 shows the specific capacity values of three Al cells plotted as a function of charge/discharge cycles: a cell containing a cathode roll of heavily recompressed graphene sheets (having an edge plane being parallel to the separator and in ionic contact with the separator), a cell containing a cathode roll of heavily recompressed expanded graphite flakes (having an edge plane being parallel to the separator and in ionic contact with the separator), and a cell containing a cathode of original artificial graphite. These data demonstrate that, compared with the original graphite, graphene sheets heavily recompressed to produce an oriented structure having a graphene edge plane parallel to the separator, imparts a significantly higher charge storage capacity to an aluminum-ion battery. The procedure of forming graphene sheets, followed by recompression, enables more charges to be stored as compared to the original graphite-based cathode layer. The Al cells having highly aligned graphite flakes (edge plane being parallel to the separator plane) also exhibit excellent specific capacity and very stable cycling behaviors. A higher specific capacity in the cathode also leads to a higher energy density. The presently invented aluminum cells exhibit some supercapacitor-like behavior (having long cycle life) and some lithium ion battery-like behavior (moderate energy density).

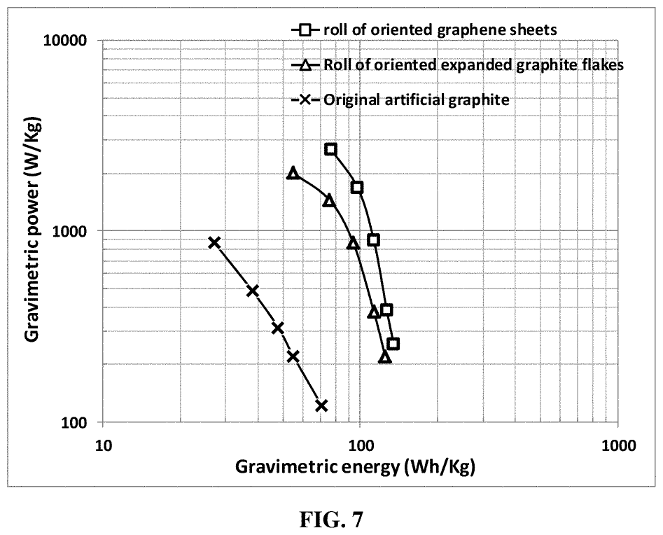

Shown in FIG. 7 are the Ragone plots of three aluminum cells: a cell containing a cathode layer of original artificial graphite particles, a cell containing a cathode roll of oriented graphite flakes (edge plane parallel to the separator and contacting therewith), and a cell containing a cathode roll of oriented graphene sheets (graphene edge plane parallel to the separator and contacting therewith). The latter two were prepared via dry compression after the graphene sheets and the expanded graphite flakes were produced from the same type of artificial graphite particles. These data indicate that a cathode roll comprising oriented graphene sheets or expanded graphite sheets, having a graphene edge plane substantially parallel to the separator layer plane, leads to an aluminum cell capable of delivering a significantly higher energy density and higher power density.

We claim:

1. A rolled aluminum secondary battery comprising an anode, a cathode, a porous or ion-permeable separator electronically separating said anode and said cathode, and an electrolyte in ionic contact with said anode and said cathode to support reversible deposition and dissolution of aluminum at said anode, wherein said anode comprises aluminum metal or an aluminum metal alloy as an anode active material and said cathode comprises a wound cathode roll of a cathode active material having a cathode roll length, a cathode roll width, and a cathode roll thickness or diameter, wherein said cathode active material comprises isolated graphene sheets, expanded graphite flakes, recompressed exfoliated graphite worms having constituent graphite flakes, or a combination thereof wherein these graphene sheets or graphite flakes are aligned or oriented substantially parallel to a plane defined by said cathode roll length and said cathode roll width; and wherein said cathode roll width is substantially perpendicular to said separator in such a manner that said aligned or oriented graphene sheets or graphite flakes have a graphene edge plane in direct contact with said electrolyte and facing said separator.

2. The rolled aluminum secondary battery of claim 1, wherein said isolated graphene sheets are selected from a pristine graphene or a non-pristine graphene material, having a content of non-carbon elements greater than 2% by weight, selected from graphene oxide, reduced graphene oxide, graphene fluoride, graphene chloride, graphene bromide, graphene iodide, hydrogenated graphene, nitrogenated graphene, chemically functionalized graphene, doped graphene, or a combination thereof.

3. The rolled aluminum secondary battery of claim 1, wherein said graphene sheets, expanded graphite flakes, or exfoliated graphite worms are produced from a thermally exfoliated product of meso-phase pitch, meso-phase carbon, meso carbon micro-beads (MCMB), coke particles, expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof.

4. The aluminum secondary battery of claim 1, wherein said graphene sheets or graphite flakes are bonded together by a binder.

5. The rolled aluminum secondary battery of claim 4, wherein said binder is chemically cured while the oriented graphene sheets are in a compression state.

6. The rolled aluminum secondary battery of claim 1, wherein said wound cathode roll of aligned graphene sheets or graphite flakes has a physical density from 0.5 to 2.0 g/cm³ and has meso-scaled pores having a pore size from 2 nm to 50 nm.

7. The rolled aluminum secondary battery of claim 1, wherein said wound cathode roll of aligned graphene sheets or graphite flakes has a physical density from 1.1 to 1.8 g/cm³ and has pores having a pore size from 2 nm to 5 nm.

8. The rolled aluminum secondary battery of claim 1, wherein said wound cathode roll of aligned graphene sheets or graphite flakes has a specific surface area from 20 m^{2/}g to 2,630 m^{2/}g.

9. The rolled aluminum secondary battery of claim 1, further comprising an anode current collector supporting said aluminum metal or aluminum metal alloy or further comprising a cathode current collector supporting said aligned graphene sheets.

10. The rolled aluminum secondary battery of claim 9, wherein said anode current collector contains an integrated nano-structure of electrically conductive nanometer-scaled filaments that are interconnected to form a porous network of electron-conducting paths comprising interconnected pores, wherein said filaments have a transverse dimension less than 500 nm.

11. The rolled aluminum secondary battery of claim 10, wherein said filaments comprise an electrically conductive material selected from the group consisting of electro-spun nano fibers, vapor-grown carbon or graphite nano fibers, carbon or graphite whiskers, carbon nano-tubes, nano-scaled graphene platelets, metal nano wires, and combinations thereof.

12. The rolled aluminum secondary battery of claim 1, further comprising an anode current collector supporting said aluminum metal or aluminum metal alloy wherein said anode current collector contains (a) a layer of supporting solid substrate having two primary surfaces wherein either one or both of said primary surfaces are coated with said aluminum metal or aluminum metal alloy or (b) a layer of supporting porous substrate having pores that are impregnated with said aluminum metal or aluminum metal alloy.

13. The rolled aluminum secondary battery of claim 1, wherein said electrolyte is selected from an aqueous electrolyte, organic electrolyte, molten salt electrolyte, ionic liquid electrolyte, or a combination thereof.

14. The rolled aluminum secondary battery of claim 1, wherein said electrolyte contains AlF₃, AlCl₃, AlBr₃, AlI₃, AlFₓCl₍₃₋ₓ₎, AlBrₓCl₍₃₋ₓ₎, AlIₓCl₍₃₋ₓ₎, or a combination thereof, wherein x is from 0.01 to 2.0.

15. The rolled aluminum secondary battery of claim 1, wherein said electrolyte contains an ionic liquid that contains an aluminum salt mixed with an organic chloride selected from n-butyl-pyridinium-chloride (BuPyCl), 1-methyl-3-ethylimidazolium-chloride (MEICl), 2-dimethyl-3-propylimidazolium-chloride, 1,4-dimethyl-1,2,4-triazolium chloride (DMTC), or a mixture thereof.

16. The rolled aluminum secondary battery of claim 1, wherein the electrolyte supports reversible intercalation and de-intercalation of ions at the cathode, wherein said ions include cations, anions, or both.

17. The rolled aluminum secondary battery of claim 1, wherein said wound cathode roll of aligned graphene sheets or graphite flakes operates as a cathode current collector to collect electrons during a discharge of said aluminum secondary battery and wherein said battery contains no separate or additional cathode current collector.

18. The rolled aluminum secondary battery of claim 1, wherein said wound cathode roll of aligned graphene sheets or graphite flakes further comprises an electrically conductive binder material which bonds said oriented graphene sheets together to form a cathode electrode layer.

19. The rolled aluminum secondary battery of claim 18, wherein said electrically conductive binder material comprises coal tar pitch, petroleum pitch, meso-phase pitch, a conducting polymer, a polymeric carbon, or a derivative thereof.

20. The rolled aluminum secondary battery of claim 1, wherein said battery has an average discharge voltage no less than 1.5 volt and a cathode specific capacity greater than 100 mAh/g based on a total cathode active layer weight.

21. The rolled aluminum secondary battery of claim 1, wherein said battery has an average discharge voltage no less than 1.5 volt and a cathode specific capacity greater than 150 mAh/g based on a total cathode active layer weight.

22. The rolled aluminum secondary battery of claim 1, wherein said battery has an average discharge voltage no less than 2.0 volts and a cathode specific capacity greater than 100 mAh/g based on a total cathode active layer weight.

23. A rolled aluminum secondary battery comprising an anode current collector, an anode, a cathode, a cathode current collector, an ion-permeable separator that electronically separates said anode and said cathode, and an electrolyte in ionic contact with said anode and said cathode, wherein the anode contains aluminum metal or an aluminum metal alloy as an anode active material and the cathode contains a wound roll of an electrolyte-impregnated laminar graphene or expanded graphite structure, which is composed of multiple graphene sheets or graphite flakes being alternately spaced by thin electrolyte layers, less than 10 nm in thickness, and said multiple graphene sheets or graphite flakes are substantially aligned along a desired direction substantially perpendicular to said separator, and wherein said laminar graphene structure has a physical density from 0.5 to 1.7 g/cm³ and a specific surface area from 50 to 3,300 m²/g, when measured in a dried state of said laminar graphene or expanded graphite structure with said electrolyte removed.

24. The rolled aluminum secondary battery of claim 23, wherein said electrolyte is selected from an aqueous electrolyte, organic electrolyte, molten salt electrolyte, ionic liquid electrolyte, or a combination thereof.

25. The rolled aluminum secondary battery of claim 23, wherein said electrolyte contains AlF₃, AlCl₃, AlBr₃, AlI₃, AlFₓCl₍₃₋ₓ₎, AlBrₓCl₍₃₋ₓ₎, AlIₓCl₍₃₋ₓ₎, or a combination thereof, wherein x is from 0.01 to 2.0.

26. The rolled aluminum secondary battery of claim 23, wherein said electrolyte contains an ionic liquid that contains an aluminum salt mixed with an organic chloride selected from n-butyl-pyridinium-chloride (BuPyCl), 1-methyl-3-ethylimidazolium-chloride (MEICl), 2-dimethyl-3-propylimidazolium-chloride, 1,4-dimethyl-1,2,4-triazolium chloride (DMTC), or a mixture thereof.

27. A method of manufacturing an aluminum secondary battery, comprising:
(a) Providing an anode containing aluminum metal or an aluminum alloy;
(b) preparing a cathode roll by rolling or winding a layer of isolated graphene sheets and/or expanded graphite flakes, an optional conductive additive, and an optional binder into a roll shape; wherein said isolated graphene sheets or expanded graphite flakes are aligned or oriented perpendicular to said cathode roll thickness;
(c) providing a porous or ion-permeable separator electronically separating said anode and said cathode and an electrolyte capable of supporting reversible deposition and dissolution of aluminum at the anode and reversible adsorption/desorption and/or intercalation/de-intercalation of ions at the cathode;
(d) aligning and packing the anode, the cathode roll, and the separator layer between the anode and the cathode roll to form a battery cell in such a manner that the cathode roll width direction is substantially perpendicular to the separator plane;
wherein said roll of aligned graphene sheets or graphite flakes is oriented in such a manner that said cathode roll has a graphene edge plane in direct contact with said electrolyte and facing or contacting said separator.

28. The method of claim 27, further comprising a sub process of impregnating the battery cell with the electrolyte.

29. The method of claim 27, wherein sub process (b) comprises rolling or winding the layer of isolated graphene sheets and/or expanded graphite flakes, optional conductive additive, optional binder, and the electrolyte into a roll shape, wherein the roll shape comprises multiple graphene sheets or graphite flakes being alternately spaced by thin electrolyte layers, less than 10 nm in thickness.

30. The method of claim 27, further including providing a porous network of electrically conductive nano-filaments to support said aluminum metal or aluminum alloy at the anode.

31. The method of claim 27, wherein said electrolyte contains an aqueous electrolyte, an organic electrolyte, a molten salt electrolyte, or an ionic liquid.

32. The method of claim 27, wherein said procedure of providing the cathode roll includes (i) depositing multiple graphene sheets and/or expanded graphite flakes onto one or two primary surfaces of a solid substrate, with or without the electrolyte, to form a laminate comprising at least one graphene or expanded graphite layer; (ii) compressing the laminate to align the multiple graphene sheets or expanded graphite flakes; and (iii) rolling or winding the compressed laminate into a roll shape, with or without pre-removing or separating the solid substrate from the at least one graphene or expanded graphite layer.
